(19) United States
(12) Patent Application Publication
(10) Pub. No.: US 2026/0310953 A1
(43) Pub. Date: Oct. 8, 2026

(54) OPTICAL SENSING WITH NONLINEAR OPTICAL NEURAL NETWORKS

(71) Applicants: NTT Research, Inc., Sunnyvale, CA (US); Center for Technology Licensing, Cornell University, Ithaca, NY (US)

(72) Inventors: Tianyu Wang, Ithaca, NY (US); Mandar Sohoni, Ithaca, NY (US); Logan Wright, Ithaca, NY (US); Peter McMahon, Ithaca, NY (US)

(21) Appl. No.: 18/998,430

(22) PCT Filed: Jul. 25, 2023
(86) PCT No.: PCT/US2023/028613

§ 371 Date: Jan. 24, 2025

Related U.S. Application Data
(60) Provisional application No. 63/392,042, filed on Jul. 25, 2022.

(51) Int. Cl. G06N 3/067; G06V 10/766; G06V 10/774; G06V 10/776; G06V 10/82; G06V 10/88

(52) U.S. Cl. CPC G06N 3/067; G06V 10/766; G06V 10/774; G06V 10/776; G06V 10/82; G06V 10/88

(57) ABSTRACT

Methods, devices, and systems for optical sensing with nonlinear optical neural network (ONNs) are provided. In one aspect, a method includes: receiving light from a visual scene by a first optical linear layer in a nonlinear ONN apparatus, linearly transforming the light into first optical outputs by the first optical linear layer trained to perform a first optical linear operation, non-linearly generating second optical outputs based on the first optical outputs by an optical nonlinear layer in the ONN apparatus, and linearly transforming the second optical outputs into third optical outputs by a second optical linear layer in the ONN apparatus trained to perform a second optical linear operation. The first optical linear layer, the optical nonlinear layer, and the second optical linear layer are sequentially arranged in series in the ONN apparatus.

### CROSS-REFERENCE TO RELATED APPLICATIONS

This application claims the benefit of priority to Provisional Application No. 63/392,042, filed on Jul. 25, 2022, the entire contents of which are hereby incorporated by reference.

### TECHNICAL FIELD

This disclosure relates generally to optical neural networks, particularly to nonlinear optical neural networks.

### BACKGROUND

Optical images are ubiquitously sources of valuable information, which can be used to guide autonomous systems, to assess manufacturing processes, and to inform medical procedures and diagnoses. In all these applications, an optical system such as a microscope forms an image of a subject on a camera, which converts the photonic, analog image into an electronic, digital image. Digital images are typically many megabytes. However, for most applications, nearly all this information is redundant or irrelevant.

### SUMMARY

The present disclosure describes methods, apparatus, and systems for optical sensing with nonlinear optical neural networks.

One aspect of the present disclosure features a method, including: receiving light from a visual scene by a first optical linear layer in a nonlinear optical neural network (ONN) apparatus; linearly transforming the light into first optical outputs by the first optical linear layer that is trained to perform a first optical linear operation; nonlinearly generating second optical outputs based on the first optical outputs by an optical nonlinear layer in the ONN apparatus; and linearly transforming the second optical outputs into third optical outputs by a second optical linear layer in the ONN apparatus that is trained to perform a second optical linear operation corresponding to the first linear optical operation. The first optical linear layer, the optical nonlinear layer, and the second optical linear layer are sequentially arranged in series in the ONN apparatus.

In some embodiments, the method further includes: performing, by an optoelectronic device coupled to the ONN apparatus, an optical-to-electrical (OE) conversion of an optical output signal of the ONN apparatus into an electrical data signal. The optoelectronic device can include one or more photodetectors.

In some embodiments, the method further includes: processing, by a computing device coupled to the optoelectronic device, digital data associated with the electrical data signal to generate a digital output corresponding to the visual scene.

In some embodiments, the digital output identifies one or more objects in the visual scene. An identification accuracy of the digital output can be higher than an identification accuracy of a digital output using a second apparatus that includes an optical linear layer followed by a digital linear layer without nonlinearity.

In some embodiments, an information percentage of an object at interest in an optical output signal from the nonlinear ONN apparatus is at least one order of magnitude higher than an information percentage of the object at interest in the light from the visual scene received by the nonlinear ONN apparatus.

In some embodiments, the light includes incoherent light or coherent light. In some embodiments, the light includes different colors of light corresponding to a plurality of wavelengths, and at least one of the first optical linear layer or the second optical linear layer is configured to perform a respective optical linear operation for each of the plurality of wavelengths.

In some embodiments, the light from the visual scene includes at least one of reflected light, scattered light, transmitted light, diffracted light, or excited light. In some embodiments, the visual scene includes at least one of: an image, a video, a real-life scene, a virtual scene, a two-dimensional (2D) object, or a three-dimensional (3D) object. In some embodiments, the visual scene includes at least one of: an image of a plurality of drawings corresponding to one or more objects, one or more real-scene objects, or one or more fluorescence images of biological objects.

In some embodiments, at least one of the first optical linear operation or the second optical linear operation includes at least one of multiplication, convolution, or multiplexing. The first optical linear operation can be same as the second optical linear operation.

In some embodiments, at least one of the first optical linear layer and the second optical linear layer includes: an optical fan-out device configured to multiplex one optical input into multiple optical inputs; an optical modulator arranged downstream of the optical fan-out device and configured to modulate corresponding weights to the multiple optical inputs to generate multiple weighted optical inputs; and an optical fan-in device arranged downstream of the optical modulator and configured to sum up the multiple weighted optical inputs into one or more optical outputs, where each of the one or more optical outputs corresponds to two or more respective weighted optical inputs.

In some embodiments, the optical fan-out device includes a microlens array. In some embodiments, the optical modulator includes a spatial light modulator (SLM). In some embodiments, the optical fan-in device includes an optical lens, a microlens array, or a waveguide.

In some embodiments, the first optical linear layer and the second optical linear layer are trained together in a digital neural network model corresponding to the ONN apparatus. In some embodiments, the optical nonlinear layer includes an optical nonlinear device configured to perform an optical nonlinear operation, and the optical nonlinear operation includes at least one of optical amplifying, saturating, or rectifying and attenuating. The optical nonlinear operation can correspond to a ReLU function, a sigmoid function, or an unconventional nonlinear function that is different from a nonlinear function used in digital computing. The optical nonlinear operation can be unrelated to the first optical linear operation and the second optical linear operation.

In some embodiments, the optical nonlinear device includes an optical intensifier, a photoconductor configured to response nonlinearly to light intensity, a light source configured to response nonlinearly to a driving current, or a nonlinear optical medium.

In some embodiments, the method further includes: calibrating the optical nonlinear device to determine at least one property of the optical nonlinear device. In some embodiments, calibrating the optical nonlinear device includes: measuring an input intensity into the optical nonlinear device, measuring an output intensity from the optical nonlinear device, and determining a mathematical function or model between the input intensity and the output intensity.

In some embodiments, the method further includes: building a digital neural network model corresponding to the ONN apparatus based on the at least one property of the optical nonlinear device, and training the digital neural network model to determine one or more parameters for the first optical linear layer and the second optical linear layer.

In some embodiments, the method further includes: controlling the first optical linear layer and the second optical linear layer in the ONN apparatus with the determined parameters, measuring the first optical outputs for the first optical linear layer; measuring the third optical outputs for the second optical linear layer; first comparing the measured first optical outputs to first ground truth information for the first optical linear layer; second comparing the measured third optical outputs to second ground truth information for the second optical linear layer; and calibrating the ONN apparatus or re-training the digital neural network model based on a first result of the first comparing and a second result of the second comparing.

In some embodiments, at least one of the first result or the second result includes: a plurality of error calibration curves or root mean square error (RMSE) values.

In some embodiments, the method further includes: training the digital neural network model by adjusting the one or more parameters for the first optical linear layer and the second optical linear layer to achieve a performance result substantially close to a performance result obtained by using a ground truth neural network.

In some embodiments, the method further includes: performing data augmentation on training data of the digital neural network model with random image misalignments and convolutions.

In some embodiments, the method further includes: performing layer-by-layer fine tuning of the digital neural network model with experimentally collected data.

In some embodiments, a ratio between an intensity of the light and an intensity of the third optical outputs is more than two orders of magnitude.

In some embodiments, the ONN apparatus includes a plurality of optical nonlinear layers, each of the plurality of optical nonlinear layers being coupled between adjacent optical linear layers. In some embodiments, the ONN apparatus includes multiple pairs of optical nonlinear layer and optical linear layer that are sequentially arranged downstream the first optical linear layer.

In some embodiments, the method further includes: using feature vectors produced by the ONN apparatus as input to a digital backend for a further operation that includes at least one of neural-network decoding or image reconstruction, unsupervised learning, or nonlinear regression.

Another aspect of the present disclosure features a method, including: receiving incoherent light from a visual scene by an optical neural network (ONN) apparatus; linearly transforming the light into first optical outputs according to a first optical linear operation by the ONN apparatus; nonlinearly generating second optical outputs based on the first optical outputs according to an optical nonlinear operation by the ONN apparatus; and linearly transforming the second optical outputs into third optical outputs according to a second optical linear operation by the ONN apparatus, the second optical linear operation corresponding to the first linear optical operation In some embodiments, the visual scene includes at least one of: an image, a video, a real-life scene, a virtual scene, a two-dimensional (2D) object, or a three-dimensional (3D) object.

In some embodiments, each of the first optical linear operation or the second optical linear operation includes at least one of multiplication, convolution, or multiplexing, and the optical nonlinear operation includes at least one of optical amplifying, saturating, or rectifying and attenuating.

In some embodiments, the method further includes: performing, by an optoelectronic device coupled to the ONN apparatus, an optical-to-electric (OE) conversion of an optical signal output of the ONN apparatus into an electric data signal; and processing, by a computing device coupled to the optoelectronic device, digital data associated with the electric data signal to generate a digital output corresponding to the visual scene.

Another aspect of the present disclosure features an optical neural network (ONN) apparatus, including: a first optical linear layer configured to receive light from a visual scene and linearly transform the light into first optical outputs according to a first optical linear operation; an optical nonlinear layer coupled to the first optical linear layer and configured to nonlinearly generate second optical outputs based on the first optical outputs; and a second optical linear layer coupled to the optical nonlinear layer and configured to linearly transform the second optical outputs into third optical outputs according to a second optical linear operation corresponding to the first linear optical operation. The first optical linear layer, the optical nonlinear layer, and the second optical linear layer are sequentially coupled in series in the ONN apparatus. The ONN apparatus can be configured to be implemented as the ONN apparatus according to any one of the methods described above.

Another aspect of the present disclosure features a system, including: an optical neural network (ONN) apparatus, an optoelectronic device coupled to the ONN apparatus, and a computing device coupled to the optoelectronic device. The ONN apparatus includes: a first optical linear layer configured to receive light from a visual scene and linearly transform the light into first optical outputs according to a first optical linear operation; an optical nonlinear layer coupled to the first optical linear layer and configured to nonlinearly generate second optical outputs based on the first optical outputs; and a second optical linear layer coupled to the optical nonlinear layer and configured to linearly transform the second optical outputs into third optical outputs according to a second optical linear operation corresponding to the first linear optical operation. The first optical linear layer, the optical nonlinear layer, and the second optical linear layer are sequentially coupled in series in the ONN apparatus. The optoelectronic device is configured to perform an optical-to-electric (OE) conversion of an optical signal output of the ONN apparatus into an electric data signal, the optical signal output of the ONN apparatus being associated with the third optical outputs. The computing device is configured to process digital data associated with the electric data signal to generate a digital output corresponding to the visual scene. The ONN apparatus can be implemented according to the ONN apparatus as described above.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a schematic diagram showing a system including a nonlinear optical neural network.

FIG. 2A is a schematic diagram of an example optical linear layer for a nonlinear optical neural network.

FIG. 2B is a schematic diagram of an image intensifier as an example optical nonlinear layer of a nonlinear optical neural network.

FIG. 3 is a schematic diagram showing an example of a system including a nonlinear optical neural network.

FIG. 4 shows an example of a nonlinear optical neural network as a frontend for image sensing.

FIG. 5 shows an example of using a nonlinear optical neural network for classification of a draw set.

FIG. 6 illustrates an example draw set including drawings for multiple objects.

FIGS. 7A-7D illustrate example results in operation of a first optical linear layer in the nonlinear optical neural network of FIG. 5, including example fanned-out images for multiple objects in the draw set (7A), example weighted images by a modulator (7B), example error calibration curves (7C), and example RMSE errors (7D).

FIGS. 8A-8B illustrate example results in operation of an optical nonlinear layer in the nonlinear optical neural network of FIG. 5, including example nonlinear curves (8A) and example output (8B).

FIGS. 9A-9D illustrate example results in operation of a second optical linear layer in the nonlinear optical neural network of FIG. 5, including example fanned-out copies (9A), example weighted fanned-outs (9B), example error calibration curves (9C), and example error calibration curves after linear transformation (9D).

FIG. 10A shows comparison of test accuracy using different systems for QuickDraw dataset.

FIG. 10B shows comparison of test accuracy using different systems for MNIST dataset.

FIG. 11 shows an example of using a nonlinear optical neural network for QuickDraw image classification.

FIG. 12 shows an example of using a nonlinear optical neural network for classifying biological cells in flow cytometry.

FIG. 13 shows an example of using a nonlinear optical neural network for image sensing of real objects.

FIG. 14 shows example imaging sensing applications using results of a nonlinear optical neural network trained for classification as inputs.

FIG. 15A is a schematic diagram showing relationships between information content and test accuracy using different processing methods.

FIG. 15B is a schematic diagram showing a relationship between a number of layers of a nonlinear optical neural network and a compression metrics.

FIGS. 16A-16C show performance scaling with deeper nonlinear optical neural networks.

FIG. 17 is a flowchart of an example process of optical sensing with a nonlinear optical neural network.

Like reference numbers and designations in the various drawings indicate like elements. It is also to be understood that the various exemplary implementations shown in the figures are merely illustrative representations and are not necessarily drawn to scale.

### DETAILED DESCRIPTION

Imaging systems can produce high-resolution images that require large amounts of data transfer and storage space. For example, a 30-second video taken by a megapixel camera takes about 500 MB of hard-disk space. While these raw images contain a large amount of information, most of the information is irrelevant for specific computer-vision tasks. There can be three main reasons: (i) natural images contain sparse information, and are therefore compressible, (ii) most applications involve images of subjects with additional underlying commonalities beyond sparsity, and (iii) most information in an image is irrelevant to the image's end use.

Implementations of the present disclosure provide methods, apparatus, systems, and techniques for optical sensing with nonlinear optical neural networks (ONNs). The nonlinear ONNs can implement deep, multi-layer neural networks (NNs), which can be used for high-performance, efficient NN image processing and compression, and can be exponentially (in the number of neurons) more efficient than single-layer NNs at approximating practically relevant functions.

The techniques described in this specification produce several technical effects and/or advantages. In some embodiments, compared to information inefficiency of conventional imaging where optics is designed as a conventional imaging system, the nonlinear ONNs in the present disclosure can be configured to be an optical encoder or a computational pre-processor that can optically compress or extract relevant information from an image. Moreover, compared to techniques that optics perform only linear operations, e.g., end-to-end optimization, compressed sensing and single-pixel imaging, and coded aperture and related approaches for computational lenseless imaging, the nonlinear ONNs can also perform nonlinear operations, which can enable machine-vision systems that operate faster and more sensitively.

In some embodiments, the techniques enable optical pre-processing that allows image sensing systems to overcome a fundamental bottleneck in performance, enabling faster, smaller, and more energy-efficient image sensors. In a conventional image sensor, using a camera with C-fold fewer pixels typically leads to C-fold improvements in achievable frame rate, signal-to-noise-ratio-per-pixel, system power requirements, size, weight, and cost, and at least C-fold lower decision latency. The reason for this is that these performance metrics are directly bottlenecked by the speed and energy cost of transducing images from the optical to digital electronic domain, of transporting them from the sensor to post-processor, and of post-processing high-dimensional digital image data. However, imaging pixel resolution cannot be reduced significantly without losing important content. This fundamental trade-off can be circumvented by using optical encoders to compress images into a low-dimensional feature space. In most applications, compression by >>10 times is in principle feasible. However, while such high compression is routinely achievable with digital processors and neural networks, the computational capacity of simple optical encoders (such as single masks or optimized lens shapes) are rarely sufficient. Compared to the simple optical encoders, the nonlinear ONNs can perform nonlinear operations in optical pre-processing, which can compress image data into a low-dimensional latent feature space, achieving high compression ratios, e.g., more than two orders of magnitude.

In some embodiments, the techniques implement optical neural networks (ONNs), which are optoelectronic systems that optically perform mathematical operations involved in typical deep neural network (DNN) inference calculations. By taking advantage of the large number of optical modes available in space, time, or frequency, ONNs allows completely parallel, optical-domain computation of wide and densely connected layers in DNNs, potentially at orders of magnitude higher update rate than with electronics. ONNs can be ideal for enabling a new class of image sensing devices, ONN sensors, in which an ONN pre-processes data from and in the analog optical domain, prior to its conversion into digital electronics.

While linear ONNs can still expand the capabilities of end-to-end optimized image sensors compared to simpler optical systems, the pre-processing they provide is mathematically equivalent to at most a single NN layer. For example, in image sensing, a measurement, such as of an object's position, is performed by computational analysis of a digitized optical image. By optically compressing images into a low-dimensional latent space, these image sensors can operate with fewer pixels, fewer photons, allowing faster, lower latency operation. Optical neural networks (ONNs), primarily developed as accelerators for deep neural network (DNN) inference, offer a platform for processing data in the analog, optical domain. ONN-based sensors have however been limited to linear processing, effectively equivalent to single-layer NNs. In contrast, the nonlinear ONNs presented herein can implement deep, multi-layer neural networks (NNs), which can be more efficient than single-layer NNs at approximating practically relevant functions. For example, multilayer deep, nonlinear ONN encoders' ability to approximate complex functions can grow exponentially with the number of layers used. The multilayer nonlinear ONN encoder can be implemented with optoelectronic, optical-to-optical nonlinear activations, and the nonlinear pre-processing in the optical domain can enable machine-vision systems that operate faster and more sensitively.

In some embodiments, the nonlinear ONN can be a pre-processor for image sensing. The nonlinear ONN pre-processor can include optical linear layers for linear operations (e.g., matrix-vector multiplications or convolutions) and optical nonlinear layers for nonlinear operations. In some implementations, the nonlinear ONN pre-processor includes an image intensifier as an optical nonlinear layer for an optoelectronic, optical-to-optical nonlinear activation function. The addition of nonlinear activations in ONNs allows for more efficient information extraction. The optical linear layers can be implemented using a technique designed to facilitate incoherent images as direct inputs, with a microlens array for all-optical fan-out. The nonlinear ONN pre-processor can conditionally compress image data into a low-dimensional latent feature space, achieving high compression ratios, e.g., up to 800:1. With the high optical compression ratios, the nonlinear ONN pre-processor can outperform conventional image sensors and linear-ONN pre-processors on a variety of tasks, including machine-vision benchmarks, flow-cytometry image classification, and measurement and identification of objects in real scenes.

For the nonlinear ONN sensors, active illumination via coherent light sources is not strictly required, and the nonlinear ONN sensors can be operated in the more common setting of incoherent illumination. The growing multitude of ONN platforms and nonlinear activations can facilitate a range of ONN sensors. These ONN sensors may surpass conventional sensors by pre-processing optical information in spatial, temporal, and/or spectral dimensions, and with possibly coherent and quantum qualities, all natively in the optical domain. Given the numerous ONN platforms and optical nonlinear activations, a multitude of deep ONN sensors may be sensitive to information encoded in light's spatial, spectral, and/or temporal degrees of freedom.

In some embodiments, the nonlinear, multilayer optical neural network (ONN) image pre-processors enable image sensors that outperform both image sensors based on conventional direct imaging, and those with only linear optical pre-processing. The advantages of performing deep, nonlinear optical image pre-processing are evident across a diverse range of image sensing tasks. Furthermore, the performance advantages of nonlinear ONN encoders can scale favorably with additional layers of ONN pre-processing. Such nonlinear optical encoders can extend the paradigm of end-to-end image system optimization to include more powerful nonlinear optical image pre-processing. The nonlinear ONN sensors can provide versatile, almost universal frontends for processing images in the analog, optical domain, facilitating both quantitative and qualitative advances throughout image sensing and machine vision.

Although the performance advantages possible with ONN-based optical frontends might appear to come at the cost of increasing overall device complexity, the opposite may turn out to be true. In traditional optical sensors, an optical system needs to be optimized to agnostically preserve as much information in the incident optical signal as possible, since any of the image's content could in principle be relevant to the end use. In an ONN-based sensor, the amount of information that needs to be preserved can be far less (only the relevant information), and distortions (including many manufacturing imperfections) may simply be adapted to by parameter adjustments, enabling, in principle, smaller, cheaper, and cheaper-to-manufacture optoelectronic systems. Moreover, the ONN-based sensors can be implemented with relevant optoelectronics and nanophotonics technologies. The wide ranging, rapid modern developments of these technologies can create low-cost, mass-manufacturable and small-footprint realizations of devices or components for the ONN-based sensors, such as two-dimensional (2D) material optoelectronics, optical metasurfaces, large-scale vertical external-cavity surface-emitting layer (VECSEL) arrays, as well as silicon nanophotonics and micro-optoelectronics.

The nonlinear, multilayer ONN image pre-processors can be used to compress analog optical information, eliminating or greatly reducing the requirements for digital post-processing. The techniques herein may therefore find use beyond deep learning acceleration, enabling ONN sensors that go beyond incoherent image sensing, encompassing intelligent sensors based on spectroscopy, hyperspectral or coherent imaging, light detection and ranging (LiDAR), and many other sensing modalities based on the diverse forms and degrees-of-freedom of light. The techniques implemented herein can even develop optical deep learning accelerator hardware for scaling deep neural network models and for processing information encoded not just in optical spatial modes, but also in time, frequency or mixed domains.

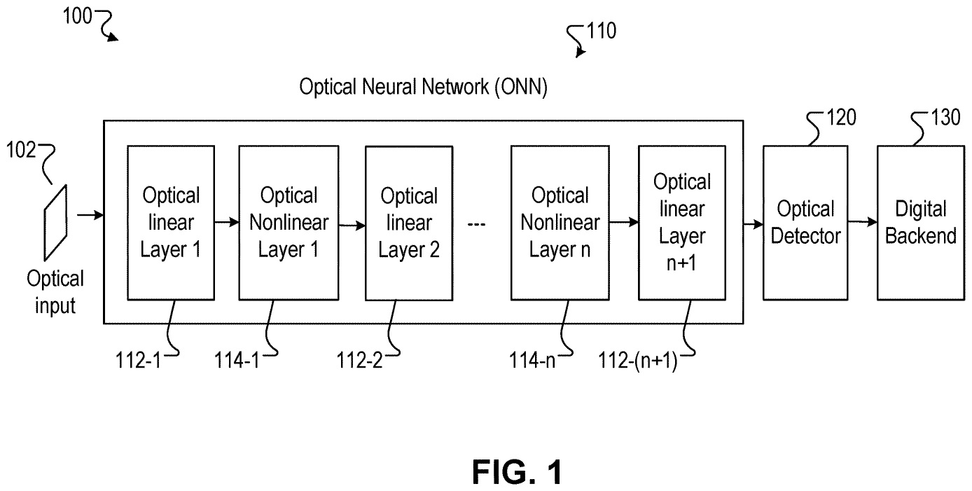

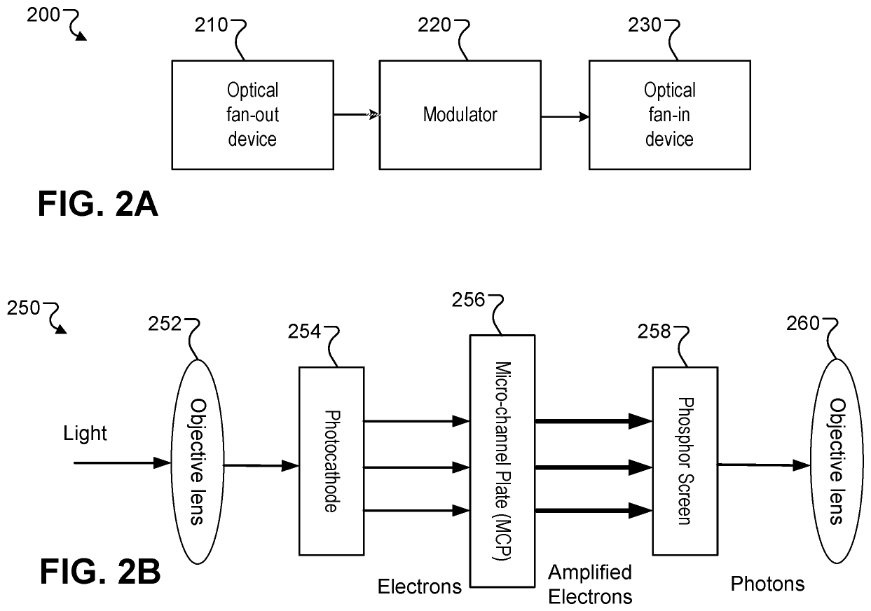

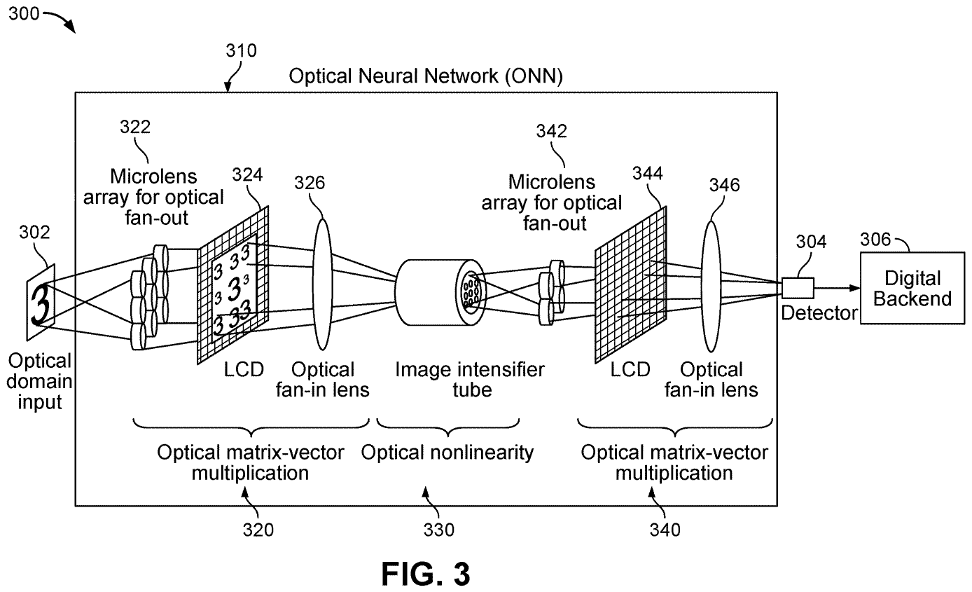

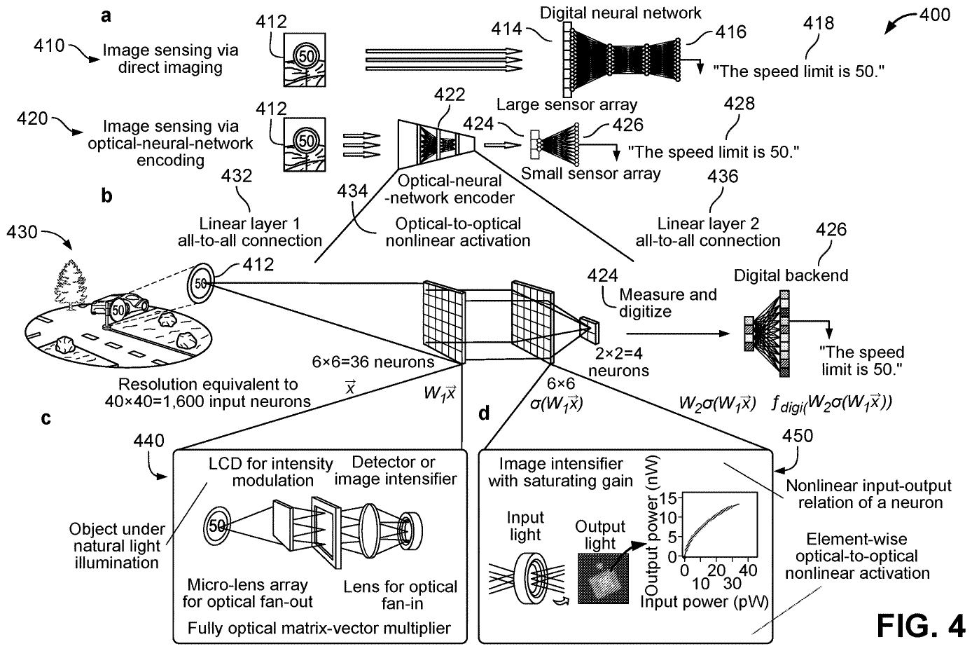

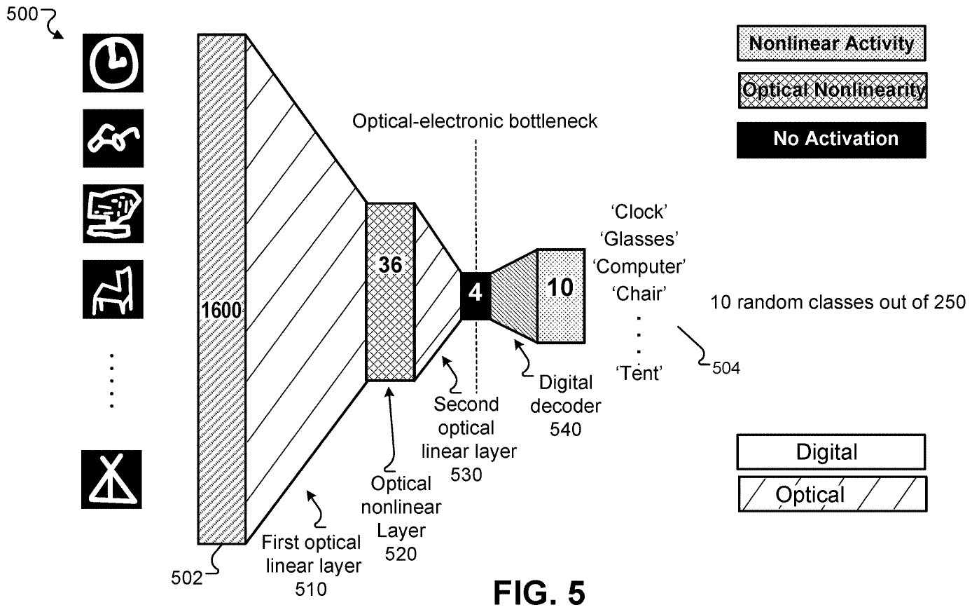

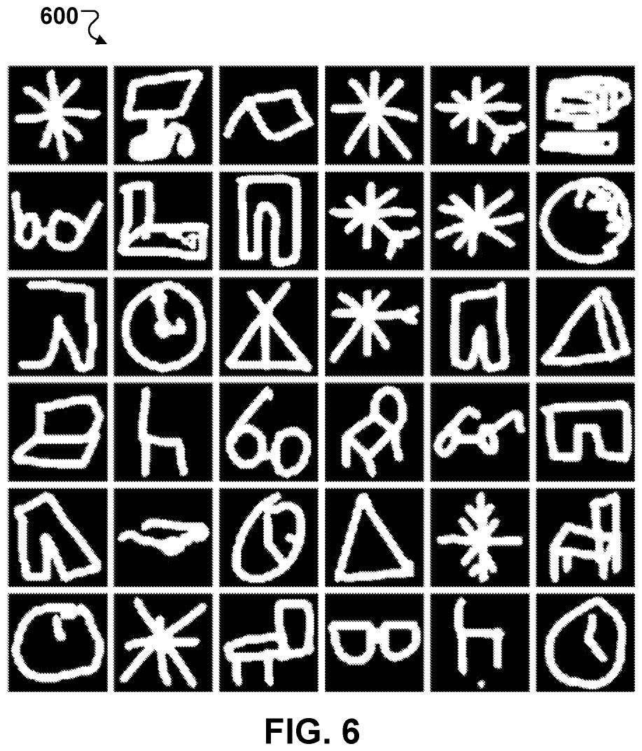

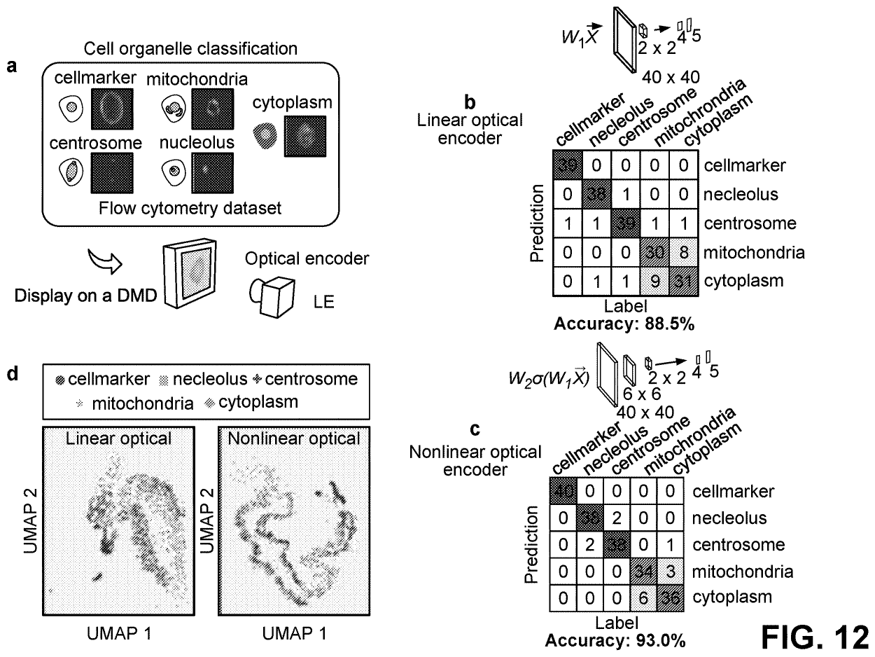

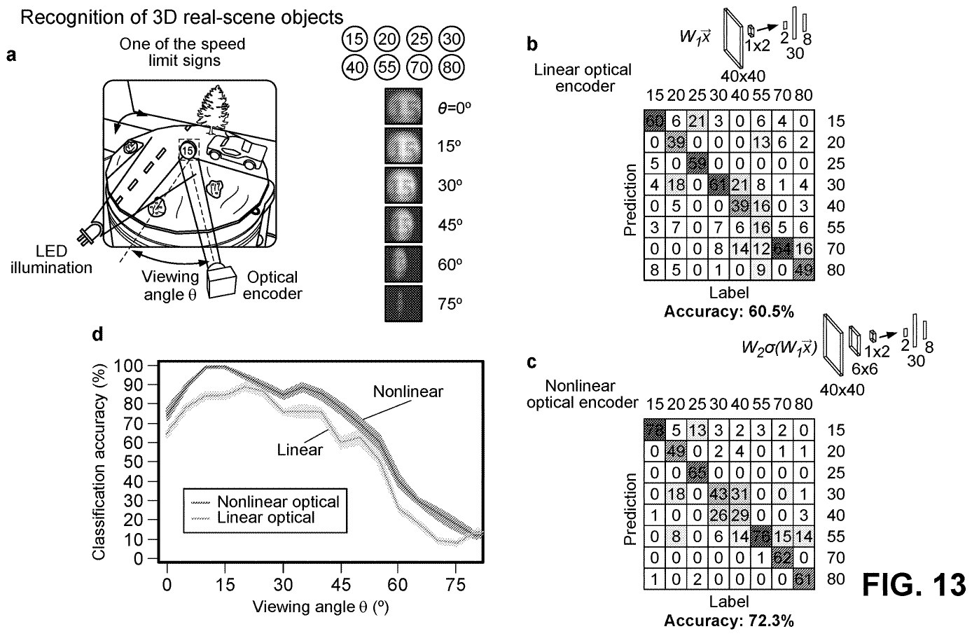

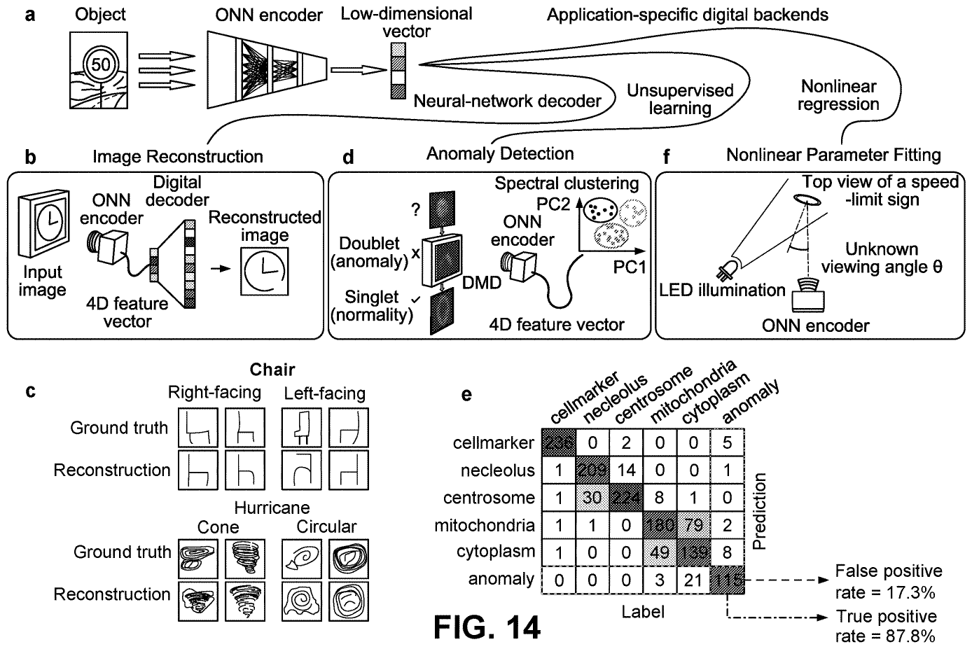

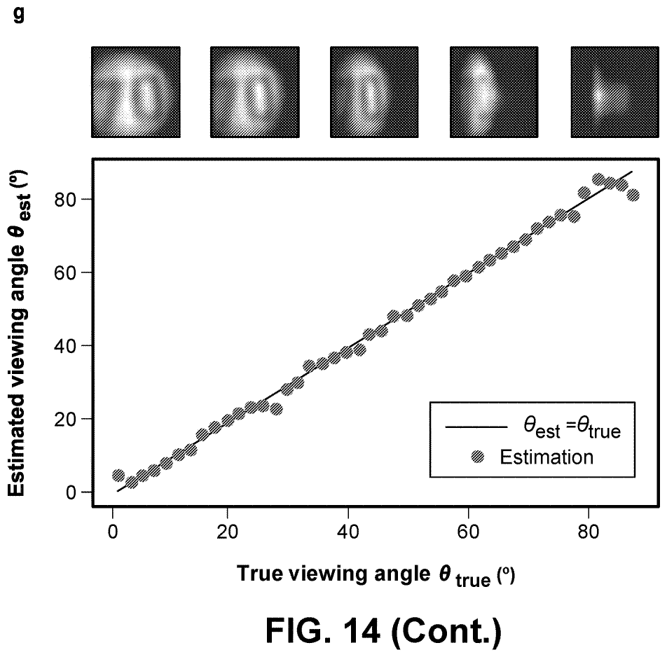

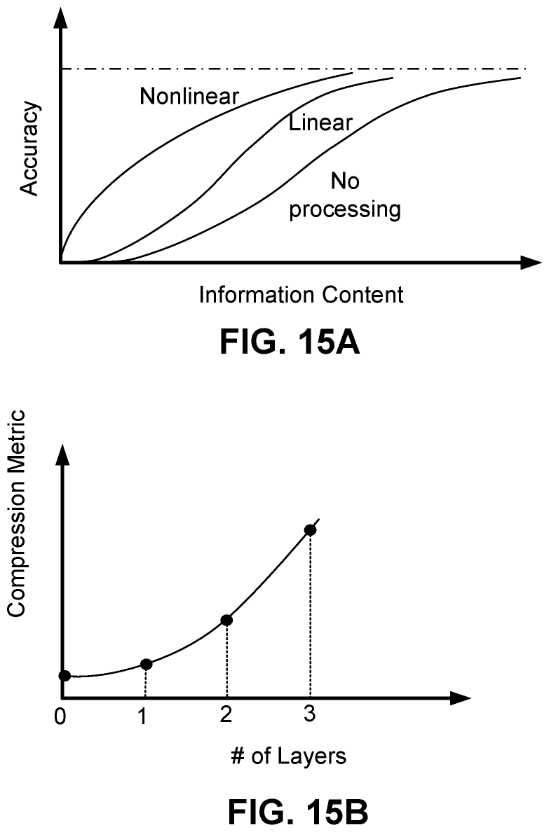

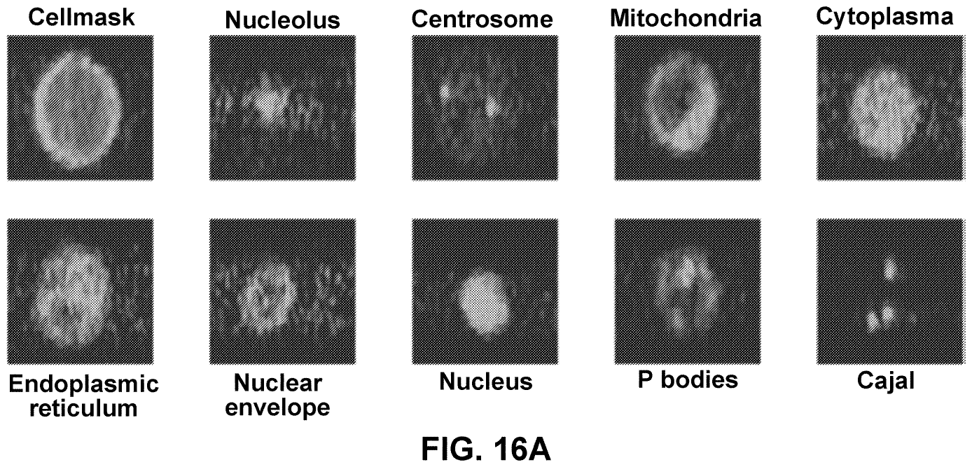

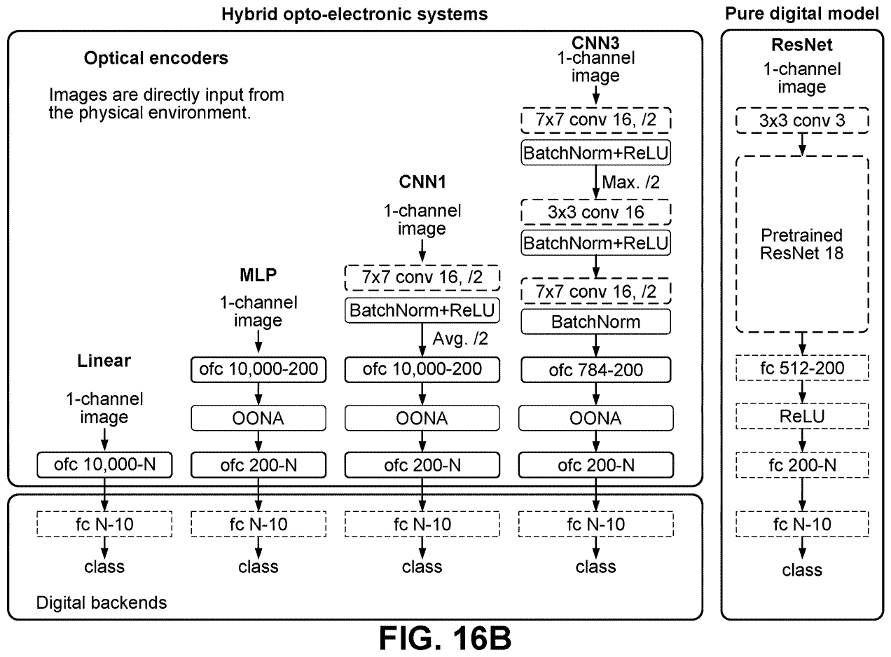

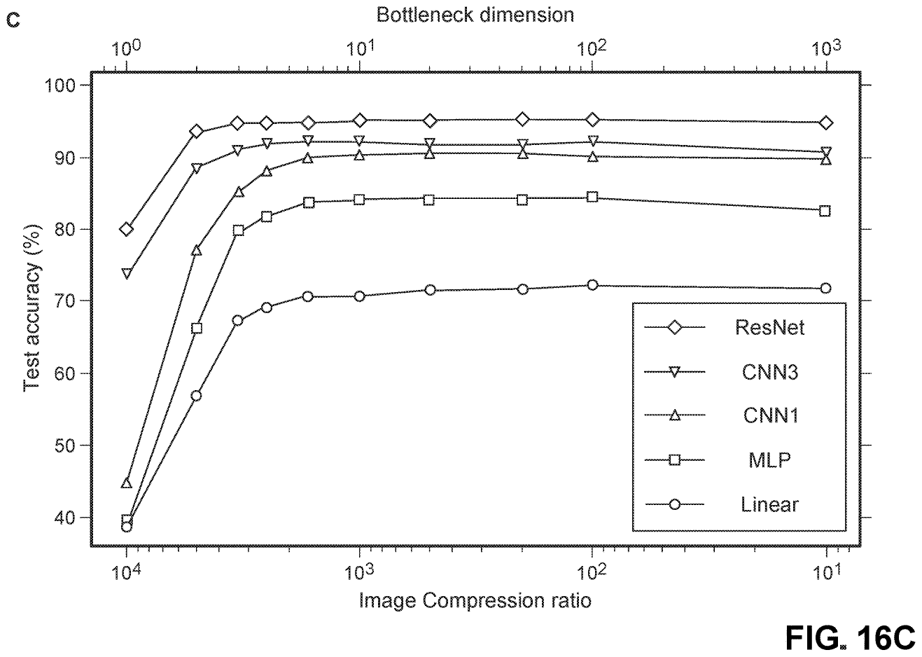

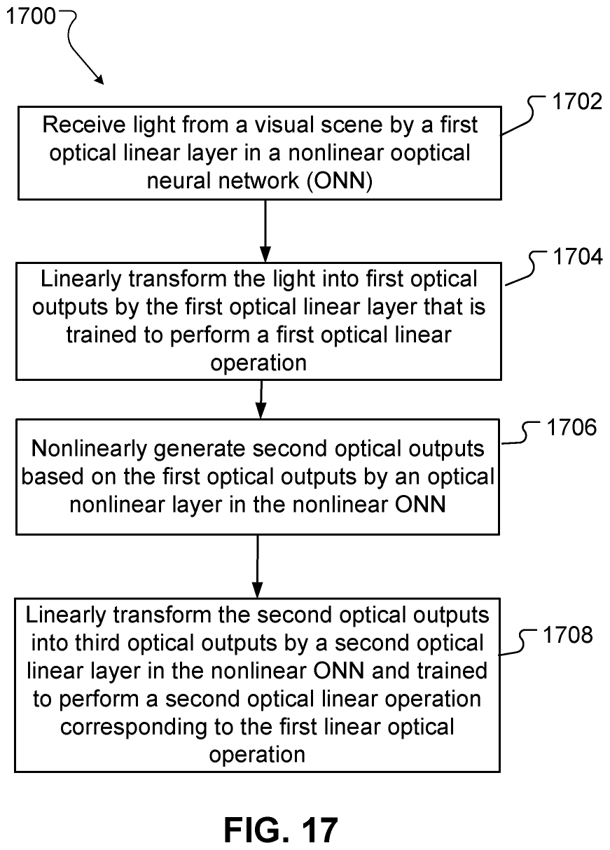

Implementations of the present disclosure are further described with more details below, including but not limited to: example systems including nonlinear ONNs (FIG. 1), example optical linear layers (FIG. 2A), example optical nonlinear layers (FIG. 2B), example nonlinear ONNs for image sensing (FIG. 3) and for real-scene object sensing (FIG. 4), example nonlinear ONN training, example applications of nonlinear ONNs for drawset classification (FIGS. 5 to 11), flow cytometry (FIG. 12), and real scene-object classification (FIG. 13), example sensing applications with nonlinear ONNs for pre-processing (FIG. 14), example performance scaling nonlinear ONNs (FIGS. 15A-15B & FIGS. 16A-16C), and example processes for optical sensing with nonlinear ONNs (FIG. 17).

### Example Nonlinear ONNs and Systems

FIG. 1 is a schematic diagram showing an example system 100 including an example nonlinear optical neural network (ONN) 110 that can be configured for optical sensing. Besides the nonlinear ONN 110, the system 100 can further include an optical detector 120 and/or a digital backend 130. As discussed with further details below, in the system 100, the nonlinear ONN 110 can directly receive an optical input 102 and pre-process the optical input to compress or extract information at interest in the optical input 102 for post-processing by the digital backend 130.

In some embodiments, the optical input 102 includes light from a visual scene. The visual scene can include at least one image, a video, a real-life scene, a virtual scene, at least one two-dimensional (2D) object, or at least one three-dimensional (3D) object. As an example, the visual scene can include an image of a plurality of drawings corresponding to one or more objects, e.g., a drawset as illustrated in FIGS. 5, 6, or 11. As another example, the visual scene can also include one or more images corresponding to one or more objects at interest, e.g., images of flow cytometry as illustrated in FIG. 12. As another example, the visual scene can also include real-scene object, e.g., a speed limit sign as illustrated in FIG. 4 or FIG. 13.

The light can be incoherent light, e.g., natural light illumination (as illustrated in FIG. 4) or light illumination from light-emitted diode (LED) (as illustrated in FIG. 13). The light can be also coherent light, e.g., laser light from a laser like VECSEL. The light from the visual scene received by the nonlinear ONN 110 can include at least one of reflected light (e.g., LED light reflected from a speed limit sign as illustrated in FIG. 13), scattered light (e.g., natural light as illustrated in FIG. 3 or 4), transmitted light, diffracted light, or excited light (e.g., fluorescence image as illustrated in FIG. 12).

Incoherent light allows non-negative number algebra, and coherent light can allow real-number operations. In some embodiments, incoherent light and coherent light can both be used and can be interchangeable. In some cases, real-number operations can be performed better in terms of computing power. In some cases, light being received has to be incoherent (e.g., fluorescence) and therefore an optical neural network, like the nonlinear ONN 110, may be operated with incoherent light.

In some embodiments, the nonlinear ONN 110 includes a multiple layer structure or architecture that includes at least two optical linear layers and at least one optical nonlinear layer, e.g., 112-1, 112-2, . . . , 112-(n+1) (referred to generally as optical linear layers 112 or individually as optical linear layer 112) and at least one optical nonlinear layer, e.g., 114-1, . . . , 114-n (referred to generally as optical nonlinear layers 114 or individually as optical nonlinear layer 114), where n is an integer and n>=1. Each optical nonlinear layer 114 is coupled between two adjacent optical linear layers 112. Multiple alternating pairs of optical nonlinear layer 114 and optical linear layer 112 can be sequentially arranged downstream the first optical linear layer 112-1. Note that for illustration purpose only, FIG. 1 shows an ONN with n>=2 to show the alternating pairs. In some examples, as illustrated in FIGS. 3 and 4, the nonlinear ONN 110 includes a first optical linear layer 112-1, a first optical nonlinear layer 114-1, and a second optical linear layer 112-2. That is, n=1.

Each optical linear layer 112 can be configured to perform an optical linear operation. The optical linear operation can be optical multiplication, optical convolution, or optical multiplexing. Different optical linear layers 112 can perform a same optical linear operation or different optical linear operations. In some embodiments, different optical linear layers 112 have a similar structure or configuration to perform the same optical linear operation, but with different parameters, e.g., as illustrated with further details in FIG. 3.

FIG. 2A is a schematic diagram of an example optical linear layer 200 for a nonlinear optical neural network (ONN). The nonlinear ONN can be the nonlinear ONN 110 of FIG. 1. The optical linear layer 200 can be implemented as the optical linear layer 112 of FIG. 1.

As illustrated in FIG. 2A, the optical linear layer 200 includes an optical fan-out device 210, an optical modulator 220, and an optical fan-in device 230. The optical linear layer 200 can be configured to perform an optical linear operation on an optical input, e.g., the optical input 102 of FIG. 1 or an optical output from a preceding optical nonlinear layer. The optical linear operation can be multiplication.

In some embodiments, the optical fan-out device 210 is configured to multiplex one optical input into multiple optical inputs. The optical fan-out device 210 can be a microlens array. The optical modulator 220 is arranged downstream of the optical fan-out device 210 and configured to modulate corresponding weights to the multiple optical inputs to generate multiple weighted optical inputs. The optical modulator 220 can be a spatial light modulator (SLM). The optical fan-in device 230 is arranged downstream of the optical modulator 220 and configured to sum up the multiple weighted optical inputs into one or more optical outputs, where each of the one or more optical outputs corresponds to two or more respective weighted optical inputs. The optical fan-in device 230 can be an optical lines, a microlens array, or a waveguide.

With continued reference to FIG. 1, each optical nonlinear layer 114 includes at least one optical nonlinear device configured to perform an optical nonlinear operation. The optical nonlinear operation can be unrelated to one or more optical linear operations performed by the optical linear layers 112. Different optical nonlinear layers 114 can perform a same optical nonlinear operation or different optical nonlinear operations. In some embodiments, different optical nonlinear layers 114 have a similar structure or configuration to perform the same optical nonlinear operation, but with different parameters.

The optical nonlinear operation can include at least one of optical amplifying, saturating, or rectifying and attenuating. The optical nonlinear operation can correspond to a ReLU function, a sigmoid function, or an unconventional nonlinear function that is different from a nonlinear function used in digital computing. In some embodiments, the optical nonlinear device includes an optical intensifier, a photoconductor configured to response nonlinearly to light intensity, a light source configured to response nonlinearly to a driving current, or a nonlinear optical medium.

FIG. 2B is a schematic diagram of an example optical nonlinear layer 250 (e.g., the optical nonlinear layer 114 of FIG. 1) of a nonlinear optical neural network (e.g., the nonlinear ONN 110 of FIG. 1). The optical nonlinear layer 250 can realize optical-to-optical nonlinearity, e.g., after a matrix-vector multiplication by an optical linear layer, and can be configured to provide large input-output gain, which is a crucial feature for multilayer networks and low-light operation.

In some embodiments, the optical nonlinear layer 250 includes an image intensifier, as illustrated in FIG. 2B. In the image intensifier, light is collected through an objective lens 252 on a photocathode 254, which produces photoelectrons in proportion to a local input light intensity. These photoelectrons are then locally amplified with a multi-channel plate (MCP) 256. The saturation of amplification in each channel of the MCP 256 provides the local optoelectronic nonlinear activation. The amplified photoelectrons in each channel then excite photons on a phosphor screen 258, producing the light input to a next layer, e.g., through another objective lens 260. The local saturation of the MCP's amplification can lead to a sigmoid-like nonlinear response, e.g., as illustrated in FIG. 4(d).

With continued reference to FIG. 1, after the nonlinear ONN 110 pre-processes the optical input 102 to generate an optical signal output, the optical detector 120, e.g., an array of photodetectors, can perform an optical-to-electrical (OE) conversion to convert the optical signal output from the nonlinear ONN 110 into an electrical data signal. The digital backend 130 can include an analog-to-digital converter (ADC) configured to convert the electrical data signal into a digital data signal and a computing device configured to process the digital data signal to generate a digital output corresponding to the visual scene. For example, as illustrated with further details in FIGS. 3, 4, 5, 11-14, the digital output identifies one or more objects in the visual scene.

An identification accuracy of the digital output is higher than an identification accuracy of a digital output using a second apparatus that includes an optical linear layer followed by a digital linear layer without nonlinearity. The higher identification accuracy can be due to a higher compression ratio caused by nonlinearity of the nonlinear ONN 110. In some examples, an information percentage of an object at interest in the optical signal output from the nonlinear ONN 110 is more than two orders of magnitude higher than an information percentage of the object at interest in the optical input 102 (e.g., the light from the visual scene) received by the nonlinear ONN 110.

In some embodiments, the optical input 102 includes different colors of light corresponding to a plurality of wavelengths. One or more optical linear layers 112 in the nonlinear ONN 110 can be configured to perform a respective optical linear operation for each of the plurality of wavelengths. The one or more optical nonlinear layers 114 can be configured to perform a same optical nonlinear operation for each of the plurality of wavelengths.

### Example Nonlinear ONN Training

Nonlinear ONN apparatus, e.g., the nonlinear ONN 110 of FIG. 1, can be trained and/or calibration before use.

In some embodiments, optical linear layers, e.g., 112 of FIG. 1, are trained together in a digital neural network model corresponding to the ONN apparatus. In some embodiments, one or more characteristics or properties of an optical nonlinear layer, e.g., 114 of FIG. 1, are measured and calibrated physically. For example, in calibration, an input intensity into the optical nonlinear and an output intensity from the optical nonlinear layer are separately and respectively measured, and then a mathematical function or model between the input intensity and the output intensity can be determined.

In some embodiments, the ONN apparatus includes a first optical linear layer, an optical nonlinear layer, and a second optical linear layer that are sequentially arranged along an optical path of light. A digital neural network model corresponding to the ONN apparatus can be built based on the one or more characteristics or properties of the optical nonlinear layer. Then the digital neural network model can be trained to determine one or more parameters for the optical linear layers.

In some embodiments, the first optical linear layer and the second optical linear layer in the ONN apparatus are controlled with the determined parameters. Then, first optical outputs for the first optical linear layer and second optical outputs for the second optical linear layer are measured. The measured first optical outputs can be compared to first ground truth information for the first optical linear layer. The measured third optical outputs can be compared to second ground truth information for the second optical linear layer. The ONN apparatus can be calibrated or the digital neural network model can be retrained based on a first result of the first comparing and a second result of the second comparing. The first result or the second result can include a plurality of error calibration curves or root mean square error (RMSE) values.

In some embodiments, instead of comparing to the ground truth information of each layer in the nonlinear ONN apparatus, the nonlinear ONN apparatus can be calibrated or the digital neural network model can be re-trained by adjusting the one or more parameters of the first optical linear layer and the second optical linear layer to achieve a performance result substantially close to a performance result obtained by using a ground truth neural network. For example, layers after a current layer in the nonlinear ONN apparatus are retrained to recover a performance of the nonlinear ONN apparatus (e.g., a classification accuracy or a detection accuracy) as much as possible in comparison to a ground truth neural network. In this approach, each layer can not turn out to be identical to the ground truth.

In some embodiments, training of the optical neural network layers (e.g., optical linear layers and optical nonlinear layer(s)) is achieved primarily by creating an accurate digital model of the optical neural network layers and training the digital model's parameters together with digital post-processing layer(s). For example, the digital model can treat each matrix-vector multiplier as a fully connected layer, and include individually calibrated nonlinear curves for activation functions of the optical nonlinear layer.

To improve the robustness of the digital model and allow to be accurately implemented, three key techniques can be used: an accurate calibrated digital model as described above, physics-inspired data augmentation, and a layer-by-layer fine-tuning with experimentally collected data.

Data augmentation can be performed on training data with random image misalignments and convolutions, which are configured (or intended) to mimic realistic optical aberrations and misalignments. This can include random rotations (e.g., ±5 degrees), translations (e.g., ±4% of the image size in each direction), a mismatched zoom factor (e.g., ±4% image scale) and interpixel crosstalk, implemented as a blurring kernel (e.g., a 3×3 blurring kernel). These measures can not only make models more resilient to errors in the imaging optics, but also make the models more tolerant of analog photon noise, and no additional low-precision training (e.g., quantization-aware training) is required. To manage the computational cost of this augmentation, it may be sufficient to only apply these augmentations to an input layer (e.g., the first optical linear layer 112-1 of FIG. 1). The hidden layers result in relatively sparse activations, and the interpixel crosstalk can be more easily ignored. Noise on the forward pass can be also added during training of about 2% to each activation, after both the first optical linear layer and the second optical nonlinear layer.

In some embodiments, the models can be first trained entirely digitally. A stochastic gradient optimizer can be used for training with a learning rate, e.g., between 0.03 and 0.05, and a momentum, e.g., between 0.7 and 1. Learning rate decay can be applied, e.g., every 20 epochs, with a decaying rate, e.g., between 0.3 and 0.5. The training parameters can be randomly generated within the range for different trials of training, and fine-tuned. In some examples, the training of each model takes 100 epochs. A number of models, e.g., several hundred models, can be trained for the optical neural network layers, each with slightly different randomly generated training parameters. Afterwards, each model can be executed with simulated shot noise at different photon budgets, and then the model yielding the best accuracy at low photon budgets can be chosen to be run on the ONN setup.

After this digital training step, the trained models can be fine-tuned using a layer-by-layer training scheme that incorporated data collected from an experimental device. First, the weights for the first optical layer obtained digitally can be uploaded, and the nonlinear activations for each training image after the optical nonlinear layer (e.g., an image intensifier) can be obtained using a monitor imaging system. Using these images as the input, the second optical linear layer and a digital layer can be re-trained. the obtained weights for the second optical linear layer can be then uploaded, and for each image in the training set, the output from the second layer experimentally is collected, which can be used to finally retrain a last digital linear layer. After the layer-by-layer fine-tuning, experimental testing with a test data set can be performed.

### Example Nonlinear ONNs for Image Sensing

FIG. 3 is a schematic diagram showing an example system 300 including a nonlinear optical neural network (ONN) 310. The system 300 can be similar to or same as the system 100 of FIG. 1 and configured for image sensing. The system 300 includes the nonlinear ONN 310 (e.g., the nonlinear ONN 110 of FIG. 1), an optical detector 304 (e.g., the optical detector 120 of FIG. 1), and a digital backend 306 (e.g., the digital backend 130 of FIG. 1).

The nonlinear ONN 310 can function as an optical pre-processor to extract or compress information in an optical domain input 302 that can be the optical input 102 of FIG. 1. For example, as illustrated in FIG. 3, the optical domain input 302 can include an object at interest, number “3”, in an image. The nonlinear ONN 310 can be configured to extract information of the object at interest and optically output the extracted information of the object at interest to the optical detector 304 that can convert an optical output signal into an electrical data signal. The electrical data signal can be subsequently digitally post-processed by the digital backend 306, e.g., to identify the number “3” in the image.

As shown in FIG. 3, the nonlinear ONN 310 includes a first optical linear layer 320, an optical nonlinear layer 330, and a second optical linear layer 340. Each of the first optical linear layer 320 and the second optical linear layer 340 can be similar to, or same as, the optical linear layer 112 of FIG. 1 or the optical linear layer 200 of FIG. 2A, and configured to perform optical matrix-vector multiplication as an optical matrix-vector multiplier unit. For example, the first optical linear layer 320 can include an optical fan-out element 322, an optical modulator 324, and an optical fan-in element 326; and the second optical linear layer 340 can also include an optical fan-out element 342, an optical modulator 344, and an optical fan-in element 346.

The optical fan-out element 322, 342 can be similar to the optical fan-out device 210 of FIG. 2A, e.g., a microlens array. However, the microlens array for the optical fan-out element 342 can have a smaller size than the microlens array for the optical fan-in element 322, as shown in FIG. 3, due to a compression of the optical domain input 302. The optical modulator 324, 344 can be similar to, or same as, the optical modulator 220 of FIG. 2A, e.g., an SLM. The optical fan-in element 326, 346 can be similar to, or same as, the optical-in element 230 of FIG. 2A, e.g., an optical lens.

In some examples, the optical fan-out element 322, 324 are realized by a micro-lens array configured to produce multiple copies of the input image in different regions of a liquid crystal display (LCD) that is used as a transmissive spatial light modulator (SLM). For the first optical linear layer 320, the micro-lens array for the optical fan-out element 322 has a square array as a pitch of 1.1±0.001 mm and a focal length of 128.8 mm (e.g., APO-Q-P1100-F105, OKO optics). For the second optical linear layer 340, the microlens array for the optical fan-out element 324 has a rectangular pitch of 4 mm×3 mm and a focal length of 38.10 mm, with a total of 63 lenslets (e.g., #63-230, Edmund Optics).

The weights of each optical linear layer 320, 340 can be stored as values of pixels on the optical modulators 324, 344 (e.g., LCDs that both are Sony LCX029, with LCX017 controllers). Each LCD can be operated as transmissive intensity spatial light modulators by placing two polarizers, oriented at +45 and −45 degrees relative to the LCD grid, before and after the LCD. The LCD-based matrix-vector multipliers can be calibration or trained as described above. In some examples, under white-light illumination, an extinction ratio of the LCD pixels can be measured to be at least 400, and the LCD can provide 256 discrete modulation levels.

The optical fan-in element 326 for the first optical linear layer 320 can be implemented by demagnifying the modulated optical fan-out copies on the LCD by a demagnification factor, e.g., of 30×, through a telescope composed of a singlet lens (e.g., LA 1484-A-ML, Thorlabs Inc., f=300 mm) and an objective lens (e.g., MY20X-804, 20×, Mitutoyo, f=10 mm). The optical fan-in element 346 of the second optical linear layer 340 can be implemented using a zoom lens (e.g., Zoom 7000, Navitar Inc.) and imaged onto the optical detector 304 such as a camera (e.g., Prime 95B Scientific CMOS Camera, Teledyne Photometrics). The pixels values can be summed digitally after read-out, or can equivalently be summed in an analog manner by modification of the camera analog read-out, or by using larger pixels/photodetectors.

In some embodiments, the optical linear layer 320 is configured to be optical matrix-vector multipliers. For example, to implement an N\hat{ }′×N matrix W multiplying the N-dimensional input vector, the following steps occur. First, the optical domain input 302, e.g., an input image (vector), is fanned-out to create N\hat{ }′ identical copies, using the optical fan-out element 322 (e.g., a micro-lens array) to form N\hat{ }′ identical images on regions of the optical modulator 324 (e.g., an SLM), which contains N total pixels and corresponds to rows of the layer's weight matrix. After attenuation by the optical modulator 324, which implements the optical weight multiplication, the attenuated image copies are optically fanned-in by being imaged by the optical fan-in element 326 (e.g., an optical lens) onto N\hat{ }′ pixels of the optical nonlinear layer 330 (e.g., an image intensifier tube). Provided the size of the focused image of each attenuated copy is smaller than the resolution of the image intensifier (or size of the camera superpixel), the electronic summation of optical energy into photoelectrons achieves the summation step of the matrix-vector multiplication for each row, producing the N\hat{ }′-dimensional output vector. The optical linear layer 340 can be configured to function similar to the optical linear layer 320, except that the optical fan-in element 346 focuses an optical output onto the optical detector 304.

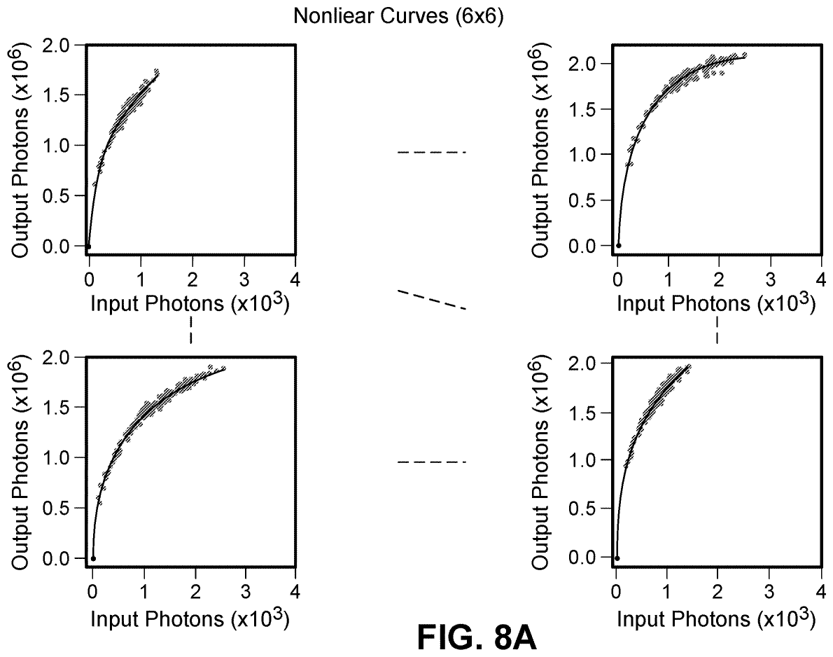

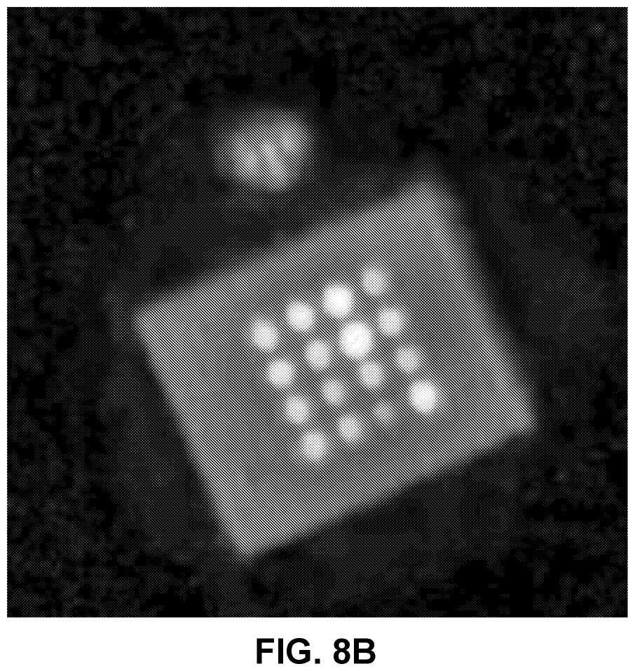

The optical nonlinear layer 330 can be similar to, or same as, the optical nonlinear layer 114 of FIG. 1 or the optical nonlinear layer 250 of FIG. 2B, and configured to perform an optical-to-optical nonlinear activation. As noted above, the optical-to-optical nonlinearity after the first matrix-vector multiplication can be realized with an image intensifier tube. The image intensifier tube can provide large input-output gain, a crucial feature for multilayer networks and low-light operation. The image intensifier tube can also resets the number of optical modes. In some examples, the image intensifier can include a S20 photocathode, 1-stage MCP and P46 phosphor. The nonlinearity of the MCP gain saturation can vary slightly from channel to channel, and the input-output response for all illuminated regions can be calibrated separately, e.g., as illustrated in FIG. 8A. In some examples, each of the input-output responses are fitted each to a curve of the form y=a(1−e\hat{ }(−bx))+c(1−e\hat{ }(−dx)), where a, b, c, d are fit parameters for each region. The image intensifier tube's response time can be measured to be approximately 20 μs.

FIG. 4 shows an example 400 of a nonlinear optical neural network (ONN) as a frontend for image sensing. The nonlinear ONN can be the nonlinear ONN 110 of FIG. 1 or the nonlinear ONN 310 of FIG. 3.

Diagram (a) shows image sensing via direct imaging 410 vs optical encoding 420. In conventional image sensing 410, an image (or an optical input) 412, e.g., natural light illumination from a real-scene object such as a speed limit sign, is collected by a large sensor array 414, and processed using a digital neural network (NN) 416 to extract a small piece of relevant information 418, such as the speed limit or text of the sign is 50. Rather than faithfully reproducing the full image of a scene, in optical encoding 420, an optical-neural-network (ONN) encoder 422 instead pre-processes the image 412, compressing and extracting only the image information necessary to its end use. The extracted information can be detected by a small sensor array 424 (e.g., a CCD camera) and processed using a digital NN 426 to extract relevant information 428. Due to the compression and extraction by the ONN encoder 422, the small sensor array 424 can be smaller than the large sensor array 414, and the digital NN 426 can be simpler and faster than the digital NN 416.

The ONN encoder 422 can be similar to, or same as, the nonlinear ONN 110 of FIG. 1 or the nonlinear ONN 310 of FIG. 3. The small sensor array 424 can be the optical detector 120 of FIG. 1 or 304 of FIG. 3. The digital NN 426 can be implemented by the digital backend 130 of FIG. 1 or the digital backend 306 of FIG. 3. The ONN encoder 422 can be a nonlinear encoder that maps input images carried by incoherent light to an abstract, lower-dimensional latent space. The ONN encoder 422 can be not intended to perform lossless image compression, but be trained to preserve only the information most relevant to a given image-sensing task.

Diagram (b) illustrates an implementation 430 of the ONN encoder 422 with corresponding mathematical operations of the ONN encoder 422. The ONN encoder 422 can include interleaved linear and nonlinear layers, including a first optical linear layer 432, an optical nonlinear layer 434, and a second optical linear layer 436, before the compressed signal is captured by the small sensor array 424. The first optical linear layer 432 can be the optical linear layer 112 of FIGS. 1, 200 of FIG. 2A, or 320 of FIG. 3. The second optical linear layer 436 can be the optical linear layer 112 of FIGS. 1, 200 of FIG. 2A, or 340 of FIG. 3. The optical nonlinear layer 434 can be the optical nonlinear layer 114 of FIGS. 1, 250 of FIG. 2B, or 330 of FIG. 3.

Diagram (c) shows an example 440 of a fully optical matrix-vector multiplier used for constructing both optical linear layers in diagram (b), which can include a micro-lens array for optical fan-out, an LCD for intensity modulation, and lens for optical fan-in. The lens can include a single optical lens and an objective lens and be configured to focus light onto the optical nonlinear layer 434 (e.g., an image intensifier) or the small sensor array 424.

Diagram (d) shows a schematic diagram 450 of the optical nonlinear layer 434 implementing an optical-to-optical nonlinear activation with a saturating image intensifier, e.g., a saturating microchannel plate inside an image intensifier. The inset plot shows that the output light intensity of a single spatial mode begins to saturate as the input light intensity increases, resembling a sigmoid activation function.

As an example, the image (or the optical input) 412 can have a resolution equivalent to 40×40=1, 600 input neurons in a light input with a vector x. The first optical linear layer 432 compresses the image 412 into 6×6=36 neurons by adding a weight matrix W₁ to obtain vector W₁x. The optical nonlinear layer 434 performs an optical-to-optical nonlinear activation to obtain 6×6=36 neurons with vector σ(W₁x). The second optical linear layer 436 performs a multiplication operation on the 36 neurons to compress into 2×2=4 neurons by adding a weight matrix W₂ to obtain vector W_{2σ}(W₁x), which is 400 less than the neurons in the image 412. The output light from the second optical linear layer 436 can be detected by the small sensor array 424, e.g., 4 binned subpixels of a camera or an array of 4 photodetectors.

### Example Nonlinear ONNs for Drawset Classification

FIG. 5 shows an example 500 of using a nonlinear optical neural network (ONN) apparatus for classification of a draw set. The nonlinear ONN apparatus can be the nonlinear ONN 110 of FIG. 1, the nonlinear ONN 310 of FIG. 3, or the nonlinear ONN 422 of FIG. 4B, and can be configured to classify different drawing classes within the draw set.
FIG. 6 illustrates an example draw set 600 including drawings for multiple objects In some embodiments, the draw set is the Quick, Draw! (QuickDraw) dataset and is used to benchmark a performance of the nonlinear ONN as an optical neural network encoder. The draw set can be (a) significantly harder than the MNIST dataset, (b) can be binarized and displayed on a digital micromirror display (DMD) without significant loss of image information. 10 classes (e.g., Clock, Chair, Computer, Eyeglasses, Tent, Snowflake, Pants, Hurricane, Flower, Crown) can be chosen arbitrarily (e.g., to ensure the classes were not too similar) from 250+ classes. The first 300 images remaining for each class can be used for the training set (e.g., a total size of 3,000) while the last 50 can be used for testing (e.g., a total size of 500).

With continued reference to FIG. 5, an optical input 502 is a 1600 (40×40 effective pixel) image that includes multiple drawings for 10 classes. For the QuickDraw image classification task, the nonlinear ONN apparatus can include a first optical linear layer 510 for performing 1600×36 matrix-vector multiplication, an optical nonlinear layer 520 for performing 36 optical-to-optical nonlinear activations, and a second optical linear layer 530 for performing a final 36×4 matrix-vector multiplication. The first optical linear layer 510 can be the optical linear layer 112 of FIG. 1, 200 of FIG. 2A, 320 of FIG. 3, or 432 of FIG. 4. The second optical linear layer 530 can be the optical linear layer 112 of FIG. 1, 200 of FIG. 2A, or 340 of FIG. 3, or 436 of FIG. 4. The optical nonlinear layer 520 can be the optical nonlinear layer 114 of FIG. 1, 250 of FIG. 2B, 330 of FIG. 3, or 434 of FIG. 4.

A digital decoder 540 can perform a single 4×10 matrix-vector multiplication to generate a classification result 504 which can include identified 10 random classes out of 250+ classes in the draw set. The digital decoder 540 can include a 2×2 photodetector array and a digital backend (e.g., a digital neural network). In comparison, a linear ONN pre-processor can just include a single 1600×4 optical matrix-vector multiplication, followed by a 4×10 digital decoder. For direct imaging, 40×40 ground truth images can be resized to 2×2 images and sent to a 4×10 digital decoder.

In some embodiments, the QuickDraw images are resized to 100×100 pixels, binarized, and then displayed on a DMD, and the DMD is then illuminated by a white-light source. Light reflected or scatted from the DMD can be broadband, incoherent ambient light. That is, the nonlinear ONN apparatus operates directly on the incoherent, broadband visible light.

The nonlinear ONN apparatus can be trained as described above. In some embodiments, to train the weights of the nonlinear ONN apparatus, input images that are seen by the nonlinear ONN apparatus are further measured. The first optical linear layer 510 can include a microlens array as optical fan-out, an LCD for optical modulation, and a lens for optical fan-in. Due to the imaging resolution and aberrations of the microlens array in the first optical linear layer 510, effective input images can differ slightly from those that are displayed on the DMD. To measure these, bounding boxes corresponding to each pixel on the LCD in the first optical linear layer 510 can be first identified by a monitor imaging system that monitored reflected light from a first pellicle beam splitter. Then, the LCD is illuminated with each QuickDraw image, leaving the LCD pixels all at their high transmission, and collected images using the same monitor image system. The effective ground truth input images can be then obtained by cropping and resizing the collected image so it can be equivalent to the illuminated LCD region. A total of 40×40 LCD pixels can be imaged by each micro-lens, so the effective input image size can be 1600.

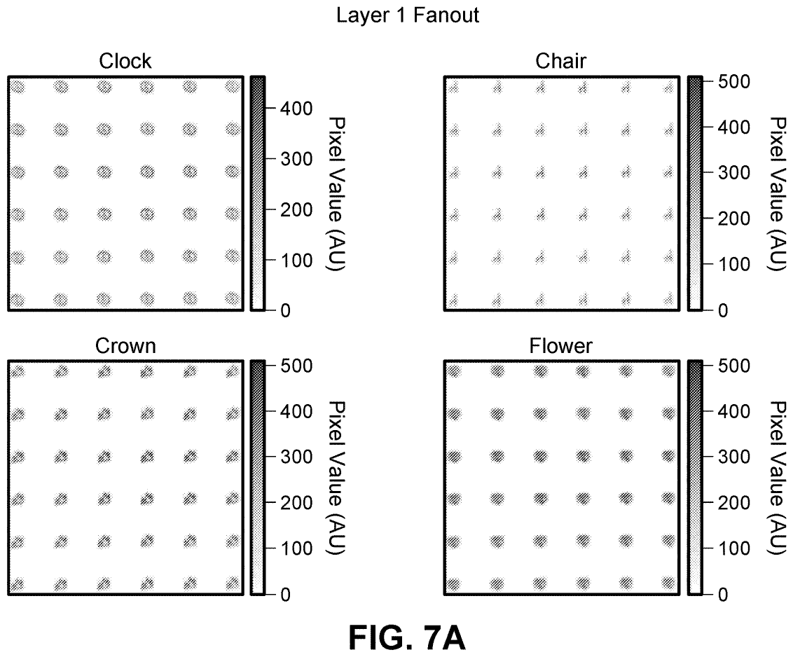

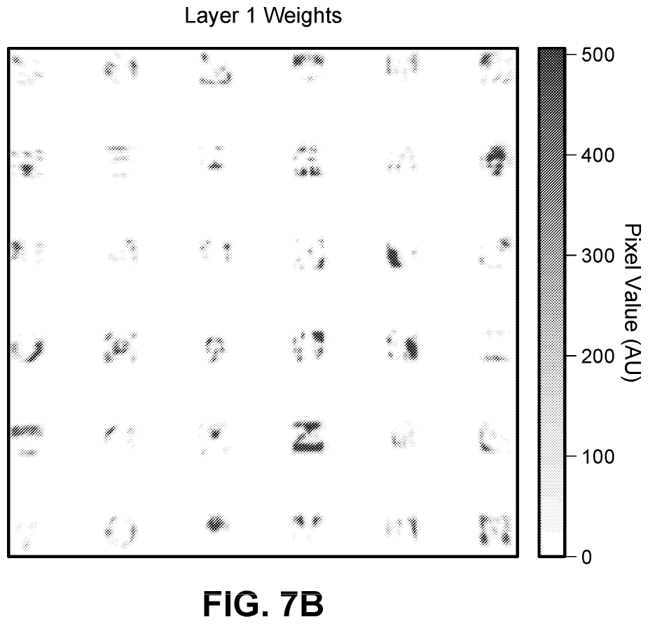

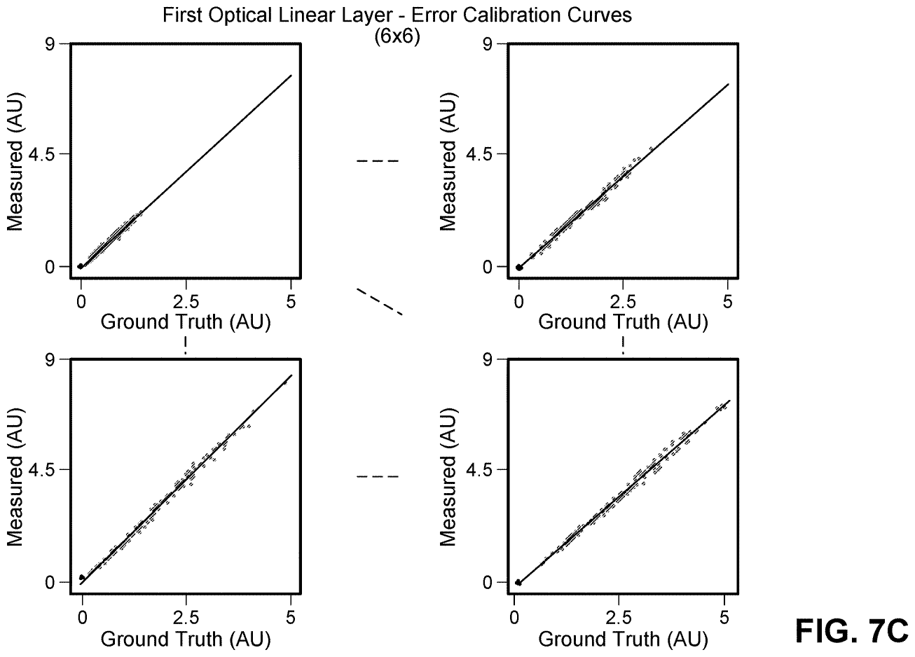

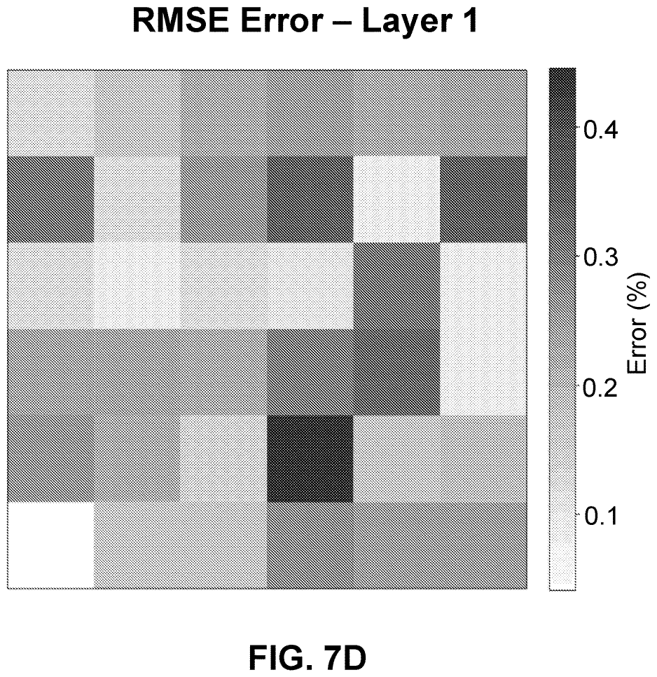

FIGS. 7A-7D illustrate example results in operation of the first optical linear layer 510 in the nonlinear ONN of FIG. 5. Particularly, FIG. 7A shows example fanned-out images for multiple classes in the draw set, including Clock, Chair, Crown, Flower. As noted above, the first optical linear layer 510 is configured to perform 1600×36 matrix-vector multiplication, and each drawing is fanned-out by the microlens array to 36 drawings. FIG. 7B shows example weighted images after the LCD modulates corresponding weights onto the fanned-out images. FIG. 7C shows example error calibration curves for each of the 36 weighted images. Each curve shows a relationship between intensity of a ground truth image and intensity of a measured weighted image. The error calibration curves indicate a linear operation performed by the first optical linear layer 510. For comparison, FIG. 7D show example RMSE errors between the intensity of the ground truth image and the intensity of the measured weighted image for each of the 36 weighted images.

FIGS. 8A-8B illustrate example results in operation of the optical nonlinear layer 520 in the nonlinear ONN of FIG. 5. FIG. 8A shows, for each of the 36 weighted images, a relationship between input photons into the optical nonlinear layer 520 and output photons out of the optical nonlinear layer 520. The number of the input photons or the output photons can be measured by light intensity. The relationship shows that the output light intensity of a single spatial mode begins to saturate as the input light intensity increases, resembling a sigmoid nonlinear activation function. FIG. 8B shows an example output light intensity from the optical nonlinear layer 520.

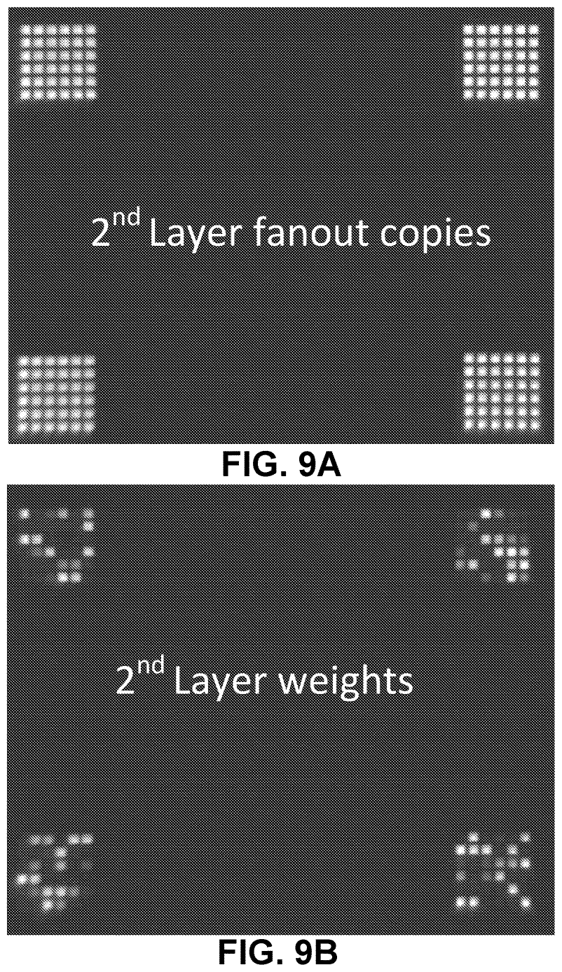

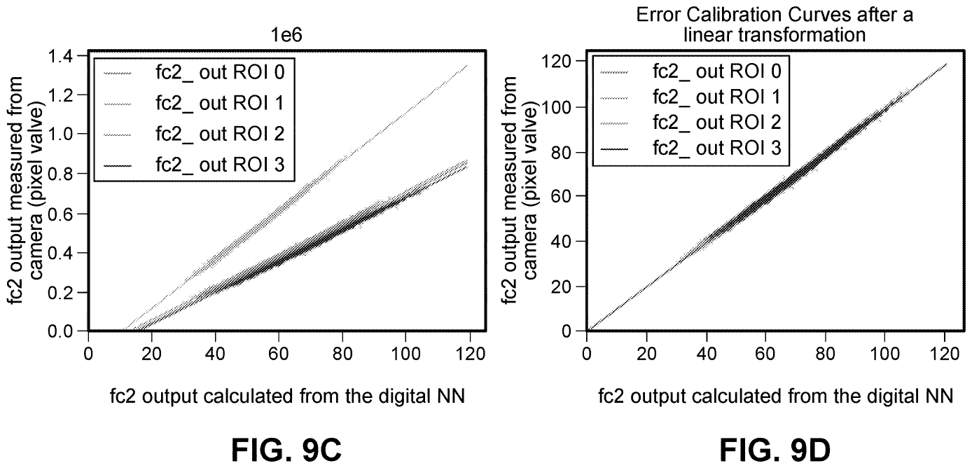

FIGS. 9A-9D illustrate example results in operation of the second optical linear layer 530 in the nonlinear ONN of FIG. 5. FIG. 9A shows example fanned-out copies after a microlens array in the second optical linear layer 530. It is shown that the 36 weighted images are multiplexed to 4 separate regions of interest (ROI). FIG. 9B shows example weighted fanned-outs by adding corresponding weights to the multiplexed weighted images with an optical modulator in the second optical linear layer 530. FIG. 9C example error calibration curves at each of the 4 regions of interest, showing a relationship between light output calculated from a digital neural network corresponding to the nonlinear ONN and light output from the nonlinear ONN measured by a camera. FIG. 9D shows the error calibration curves after a linear transformation for the 4 regions of interest, which shows a linear relationship and indicates that the nonlinear ONN is trained well with the digital neural network.

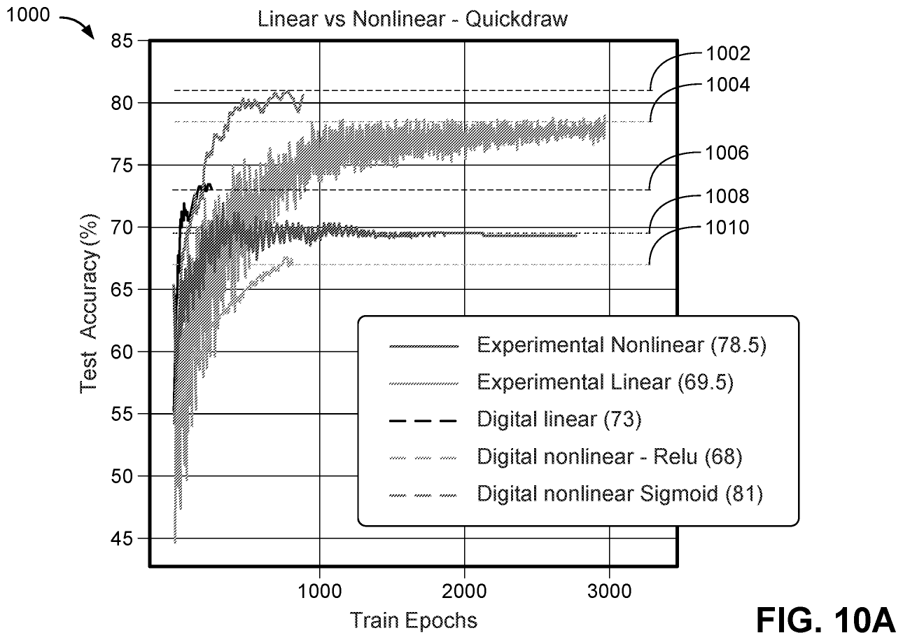

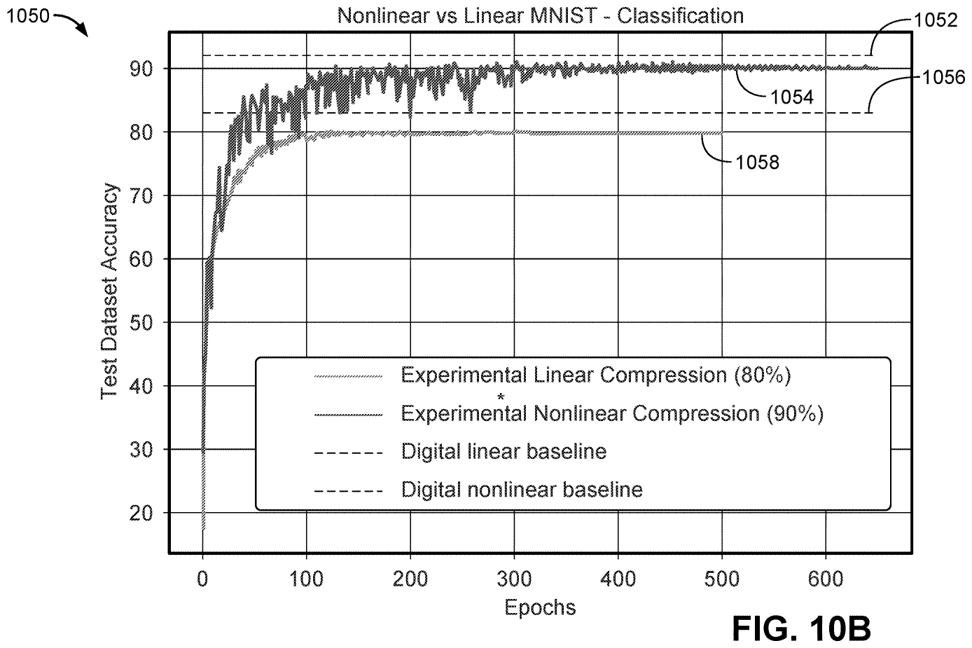

FIG. 10A shows a comparison 1000 of test accuracies varying with train epochs using different systems for drawing classes selected from QuickDraw dataset. Plot 1002 shows results using a digital nonlinear optical neural network (ONN) with Sigmoid nonlinear activation, which achieves a test accuracy of about 81%. Plot 1004 shows results using an experimental nonlinear ONN with nonlinear activation, which achieves a test accuracy of about 78.5%. Plot 1006 shows results using a digital linear ONN without nonlinear activation, which achieves a test accuracy of about 73%. Plot 1008 shows results using an experimental linear ONN without nonlinear activation, which achieves a test accuracy of about 69.5%. Plot 1010 shows results using a digital nonlinear ONN with ReLu nonlinear activation, which achieves a test accuracy of about 68%. The comparison 1000 indicates that a nonlinear ONN can achieve a higher testing accuracy with a suitable nonlinear activation function (e.g., Sigmoid) than a linear ONN.

FIG. 10B shows a comparison 1050 of test accuracies varying with train epochs using different systems for drawing classes selected from MNIST dataset. Lines 1052 and 1056 show test accuracies of digital nonlinear baseline and digital linear baseline, respectively. Plot 1054 shows results using an experimental nonlinear optical neural network (ONN) with nonlinear activation or compression, which achieves a test accuracy of about 90%, close to the digital nonlinear baseline 1052 when the number of training epochs is large (e.g., over 400 epochs). Plot 1058 shows results using an experimental linear optical neural network (ONN) with linear compression, which achieves a test accuracy of about 80% when the number of training epochs is large (e.g., over 200 epochs). The comparison 1050 shows that the nonlinear ONN can achieve a higher testing accuracy than the linear ONN when the number of training epochs is large.

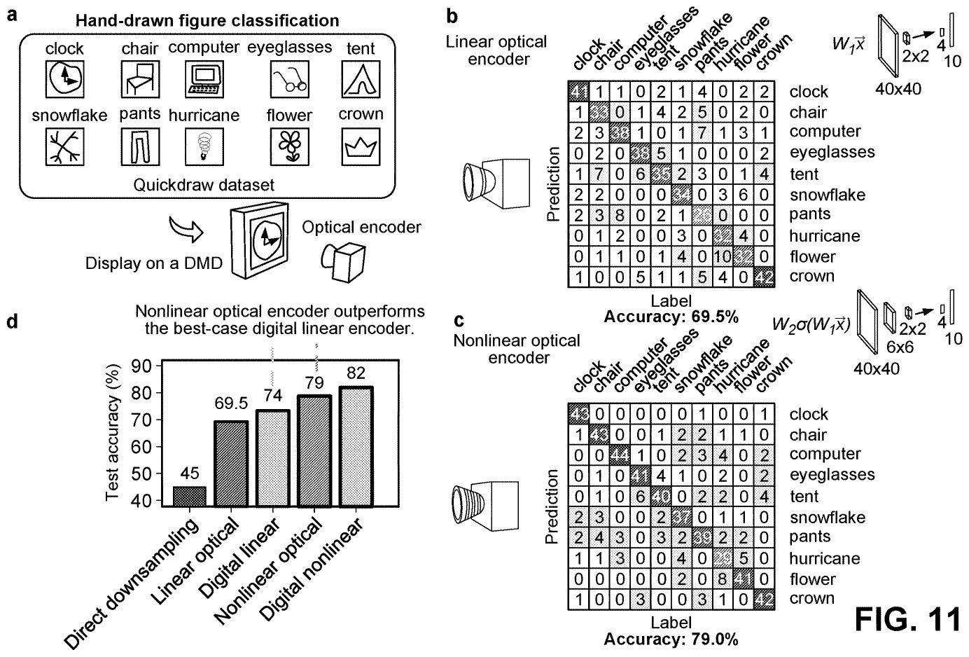

FIG. 11 shows another example of using a nonlinear optical neural network (ONN) encoder for QuickDraw image classification, in comparison with a linear ONN encoder. The nonlinear ONN encoder can be the nonlinear ONN 110 of FIG. 1, the nonlinear ONN 310 of FIGS. 3, 422 of FIG. 4, or the nonlinear ONN described in FIG. 5. The nonlinear ONN encoder has a multilayer structure, as discussed above.

To evaluate the performance of the nonlinear ONN encoder, classifiers for 10 pre-selected classes of QuickDraw image dataset are first trained. As illustrated in diagram (a) of FIG. 11, input images (e.g., 28×28 pixels) can be binarized and displayed on a digital micromirror display (DMD), which can be imaged onto each image sensor (e.g., the nonlinear ONN encoder, a linear optical encoder, and direct imaging). Diagram (b) shows the results of QuickDraw classification with the linear optical encoder as the frontend, which achieves a testing accuracy of 69.5%. Diagram (c) of FIG. 11 shows the results of QuickDraw classification with the nonlinear ONN encoder as the frontend, which achieves a testing accuracy of 79.0%. The neural-network architecture is placed above the confusion matrix it produces. Diagram (d) of FIG. 11 shows a comparison of the accuracy derived from the classifiers equipped with different frontends, including direct imaging (with downsampling), the linear optical encoder, a linear digital encoder, the nonlinear ONN encoder, and a nonlinear digital encoder (from left to right).

For a direct comparison, the vector dimension at the optical-electronic bottleneck in each classifier is the same, a 2×2 array or 4-dimensional latent space, which represents a 196:1 total image compression ratio. The nonlinear ONN encoder achieves a better classification performance than the other encoder. Since ONN components in the nonlinear ONN may be not perfectly calibrated, the nonlinear ONN encoder may perform slightly worse than digital neural networks with similar architectures. To ensure that the performance advantage of the nonlinear ONN is rigorously better than any possible linear encoder, all-digital single-layer linear and multilayer nonlinear encoders can be trained for the same task, without image downsampling. As shown in diagram (d) of FIG. 11, the nonlinear ONN encoder's performance (79% test accuracy) robustly outperforms linear encoder, beating both the optical (69.5%) and optimized digital (73%) single-layer encoders.

### Example Nonlinear ONNs for Flow Cytometry

FIG. 12 shows an example of using a nonlinear optical neural network (ONN) encoder for classifying biological cells in flow cytometry, in comparison with a linear optical encoder. The nonlinear ONN encoder can be the nonlinear ONN 110 of FIG. 1, the nonlinear ONN 310 of FIG. 3, the nonlinear ONN 422 of FIG. 4, or the nonlinear ONN described in FIG. 5. The nonlinear ONN encoder has a multilayer structure, as discussed above.

The nonlinear ONN encoder is configured to classify fluorescent images of cell organelles acquired in a flow cytometry device. Image-based flow cytometry is an emerging technique in which cells are pulled through a microfluidic tube, and imaged, ideally one-by-one, e.g. by a fluorescent and/or phase imaging microscope. The cells can be autonomously sorted if each image can be analyzed quickly to determine the type of cell or its characteristics. To process statistically useful collections of cells, so as to detect, e.g., extremely rare cancerous cells, it is essential to minimize the latency of each sorting decision to maintain a high throughput, such as 100,000 cells per second.

In some embodiments, image-based cell organelle classification in FIG. 12 uses a procedure similar to the QuickDraw classification shown in FIG. 11, including experimental collection of input ground truth images, and training procedures. As shown in diagram (a) of FIG. 12, fluorescence mages from an image set can be filtered into 5 classes based on the organelles (Nucleolus, Cytoplasm, Centrosomes, Cell Mask, Mitochondria). First 200 valid images per class can be selected for training, with the next 40 valid images per class used for testing. Invalid images, which includes images involving multiple or no cells, can be added back later for anomaly detection. Like the QuickDraw images in FIG. 11, these images can be binarized and displayed on the DMD with a 100×100 resolution, illuminated by a white light source, and classified with different optical encoders (linear optical encoder and nonlinear optical encoder).

Diagram (b) and (c) of FIG. 12 respectively show results of cell-organelle classification with a linear optical encoder and a nonlinear optical encoder (the nonlinear ONN encoder) as the frontend. The neural-network architecture is placed above the confusion matrix it resulted in. The results show that the nonlinear ONN encoder compresses input images by an effective ratio of 400:1, and results in a classification accuracy for the 5 considered classes that is better than the linear optical encoder, e.g., 93% vs 88.5% test accuracy. Diagram (d) of FIG. 12 shows visualization of the nonlinearly compressed cell-organelle data with density uniform manifold approximation and projection (DensMAP), in comparison with the linearly compressed cell-organelle data using the linear optical encoder. The data points are labeled as the ground truth.

### Example Nonlinear ONNs for Real Scene-Object Classification

FIG. 13 shows an example of using a nonlinear optical neural network for image sensing of real objects, in comparison with a linear optical encoder (or a linear ONN encoder). The nonlinear ONN encoder can be the nonlinear ONN 110 of FIG. 1, the nonlinear ONN 310 of FIG. 3, the nonlinear ONN 422 of FIG. 4, or the nonlinear ONN described in FIG. 5. The nonlinear ONN encoder has a multilayer structure, as discussed above.

Real image sensing tasks involve processing photons directly from real objects. As illustrated in diagram (a) of FIG. 13, the nonlinear ONN encoder is applied to classify traffic signs in a real model scene, e.g., illuminated by incoherent light such as LED light. Due to a limited field-of-view of a microlens array in the nonlinear ONN encoder, input images to image sensors (e.g., the nonlinear ONN encoder and the linear optical encoder) contain primarily only the speed limit sign being classified.

To train the ONN weights for the real-scene classification, ground truth input images can be collected using a procedure similar to the classification tasks performed with the DMD input. As shown in diagram (a) of FIG. 13, these images can be collected for each angle (0 to 88 degrees in 1 degree increments), for each of 8 classes (15, 20, 25, 30, 40, 55, 70 and 80 speed limits). Each speed-limit sign can be viewed from different perspectives by an optical encoder to classify the speed-limit number on the sign. Every 4th angle collected can be used in the test set, so the total dataset includes 536 images for training and 176 images for testing. All other aspects of the training and network design can be similar to the previous classifications shown in FIGS. 11 and 12, except that the compressed dimension is 2, rather than 4. As with other classifications, the compression ratio can be selected as the highest compression ratio for which the nonlinear ONN can be still able to perform the task with a reasonable accuracy.

Diagram (b) and (c) of FIG. 13 respectively show results of classifying speed limits with a linear optical encoder and a nonlinear optical encoder (the nonlinear ONN encoder) as the frontend. The neural-network architecture is placed above the confusion matrix it resulted in. Diagram (d) of FIG. 13 shows classification accuracy as a function of the viewing angle. The shaded area denotes one standard deviation from the mean for repeated classification tests. It is shown that the nonlinear ONN encoder results in better identification of the speed limit than the linear ONN encoder across a range of viewing angles from 0 to 80 degrees.

### Example Sensing Applications With Nonlinear ONNs

By training new digital post-processing only, same nonlinear ONN encoders trained for classification can be re-used for a variety of other image sensing tasks. If suitably trained, the nonlinear ONN encoders can produce robust representations of high-dimensional images in the low-dimensional latent space, which preserve far more information than the bare minimum required for classification.

FIG. 14 shows example imaging sensing applications using results of a nonlinear optical neural network (ONN) trained for classification as inputs. The nonlinear ONN encoder can be the nonlinear ONN 110 of FIG. 1, the nonlinear ONN 310 of FIG. 3, the nonlinear ONN 422 of FIG. 4, or the nonlinear ONN described in FIG. 5. The nonlinear ONN encoder has a multilayer structure, as discussed above.

For example, as diagram (a) of FIG. 14 shows, by using feature vectors produced by the nonlinear optical encoders trained for classification as input to new digital backends, including, but not limited to, neural-network decoder, unsupervised learning, and nonlinear regression, a diverse range of new image sensing tasks can be effectively performed.

Diagram (b) of FIG. 14 shows that images from the QuickDraw dataset can be reconstructed by training a new digital decoder to reconstruct, rather than classify, images from the feature vector. The encoder is the exact same ONN, including weights, as shown in FIG. 11. Diagram (c) of FIG. 14 shows that, although the encoder is only trained to preserve class information to facilitate classification, the feature space evidently preserves more complex attributes of the original images other than the class of each figure. When a digital decoder is trained to reconstruct QuickDraw images from the classification autoencoder's features, randomly selected reconstructed images show that feature information such as the direction or shape of chairs and hurricanes is evidently preserved.

Similarly, as diagram (d) of FIG. 14 shows, by performing unsupervised clustering on the feature vector produced by the cell-organelle-classifier ONN frontend (e.g., as illustrated in FIG. 12), anomalous doublet images which are not part of the encoder's training set can be accurately detected. As shown in diagram (e) of FIG. 14, the true positive rate is 87.8%, while the false positive rate is 17.3%.

In some embodiments, in image sensing applications, initial device training may not be able to account for all edge cases that may be encountered in deployment. To test the capacity for anomalies not previously observed (and for which the optical encoder is not trained on) to be detected, anomalous images of doublet cell clusters can be introduced to the ONN image sensor. To detect these anomalies, spectral clustering is run on data in the first 3 principal components of the 4-dimensional encoder latent space. This amounts to computing the eigenvalues of the Laplacian matrix of the point-to-point distance graph in this space. The first 6 eigenvalues of this matrix are observed to correspond to the 5 initially trained classes, and to a final, broadly distributed anomaly class, which allows for automated detection of these anomalous images.

Similarly, using the same nonlinear ONN encoder trained for traffic sign classification, e.g., as illustrated in FIG. 13, a new digital backend is trained to predict the viewing angle of the traffic sign images, as shown in diagrams (f) and (g) of FIG. 14. The resulting predictions are very accurate, although the performance is reduced if the network is required to predict viewing angle for all, rather than just one, speed-limit class at a time.

### Example Performance Scaling of Nonlinear ONNs

FIG. 15A is a schematic diagram showing relationships between information content and test accuracy using different optical encoders. It is shown that a nonlinear ONN encoder (e.g., the nonlinear ONN 110 of FIG. 1, the nonlinear ONN 310 of FIG. 3, the nonlinear ONN 422 of FIG. 4, or the nonlinear ONN described in FIG. 5) can achieve a higher test accuracy (e.g., for detection or classification) with less information content than a linear optical encoder (e.g., a linear ONN with compression) and an optical encoder without processing.

FIG. 15B is a schematic diagram showing a relationship between a number of optical layers in a nonlinear optical neural network (ONN) and compression metrics. It is shown that the compression metrics increases, e.g., exponentially, with the number of optical layers. The optical layers can be optical linear layers (e.g., the optical linear layer 112 of FIG. 1 or 200 of FIG. 2A), or optical nonlinear layers (e.g., the optical nonlinear layer 114 of FIG. 1 or 250 of FIG. 2B), or a combination thereof.

Results presented in FIGS. 3 to 14 illustrate that a nonlinear ONN pre-processor including one optical nonlinear layer with two optical linear layers can provide consistently better image sensing performance than conventional direct imaging or linear ONN pre-processing, across a wide range of tasks. Further, optical-to-optical nonlinearity can facilitate even deeper ONN encoders and, in turn, facilitate more sophisticated optical pre-processing.

FIGS. 16A-16C show another example of performance scaling with deeper nonlinear optical neural networks (ONNs). FIG. 16A shows thumbnails of all 10 classes of stained cell organelles for classification. FIG. 16B show different optical encoders with a same digital backend (e.g., a single layer digital decoder).

The first ONN pre-processor is a wide (e.g., 100×100=10,000-dimensional input vector), linear single-layer ONN (Linear). The second ONN pre-processor is a similarly wide network that is otherwise similar to the 2-layer fully connected ONN (MLP) and is a nonlinear encoder with two fully connected layers. The third and fourth networks extend this network deeper, adding one, for CNN1, or three, for CNN3, optical convolutional layers. For example, CNN1 is a 3-layer nonlinear ONN encoder with a convolutional layer followed by two fully connected layers, and CNN3 is a 5-layer nonlinear ONN encoder with 3 convolutional and two fully connected layers. Deeper models can produce higher accuracy, e.g., at higher compression ratios. OONA is abbreviation of optical-to-optical nonlinear activation that is performed by an optical nonlinear layer. As a reference for achievable performance, a fully digital classifier based on an ResNet model (18-layer pretrained ResNet plus 4 additional adapting layers) is also shown.

Multi-channel optical convolutional layers can be realized with 4-f systems, which can be simpler and more amenable to compact implementations than fully connected optical layers. The CNNs can also include a shifted ReLU activation (e.g., trained Batch Norm followed by ReLU), which can be realized with a slight modification of the image intensifier electronics, or by the threshold-linear behavior of optically controlled VECSEL or LED arrays. Pooling operations are AvgPool, which are straightforwardly implemented with optical summation. The MaxPool operation used once in CNN3 can be realized effectively by using a broad-area semiconductor laser or placing a master limit on the energy available to a VECSEL or LED array, such that the first unit to rise above threshold can suppress activity in others.

FIG. 16C shows how the classification performance of the different ONN pre-processors varies as the compression ratio is changed. The compression ratio is changed by modifying the number of output neurons in the final optical layer, which determines the number of pixels or photodetectors required on the photosensor. As shown in FIG. 16C, deeper ONNs, including multiple nonlinear layers, lead to progressively better classification performance across a wide range of compression ratios. The benefit of pre-processor depth becomes especially evident at very high compression ratios: for a compression ratio of 10⁴ (bottleneck dimension 1) the CNN3 pre-processor retains nearly double the accuracy of shallower networks.

### Example Process

FIG. 17 is a flow diagram of an example process 1700 of optical sensing with a nonlinear optical neural network (ONN). The nonlinear ONN can be the nonlinear ONN 100 of FIG. 1, 310 of FIG. 3, 422 of FIG. 4, or the nonlinear ONN as described in FIG. 5.

In some embodiments, the nonlinear ONN includes a first optical linear layer (e.g., the optical linear layer 112 of FIG. 1, 200 of FIG. 2A, or 320 of FIG. 3, 432 of FIG. 4), an optical nonlinear layer (e.g., 114 of FIG. 1, 250 of FIG. 2B), and a second optical linear layer which can have a similar structure as the first optical linear layer. The first optical linear layer, the optical nonlinear layer, and the second optical linear layer can be sequentially arranged in series in the nonlinear NON apparatus.

At 1702, light from a visual scene is received by the first optical linear layer in the nonlinear ONN. The visual scene can include at least one image, a video, a real-life scene, a virtual scene, at least one two-dimensional (2D) object, or at least one three-dimensional (3D) object. As an example, the visual scene can include an image of a plurality of drawings corresponding to one or more objects, e.g., a drawset as illustrated in FIGS. 5, 6, or 11. As another example, the visual scene can also include one or more images corresponding to one or more objects at interest, e.g., images of flow cytometry as illustrated in FIG. 12. As another example, the visual scene can also include real-scene object, e.g., a speed limit sign as illustrated in FIG. 4 or FIG. 13.

The light can be incoherent light, e.g., natural light illumination (as illustrated in FIG. 4) or light illumination from light-emitted diode (LED) (as illustrated in FIG. 13). The light can be also coherent light, e.g., laser light from a laser like VECSEL. The light from the visual scene received by the nonlinear ONN can include at least one of reflected light (e.g., LED light reflected from a speed limit sign as illustrated in FIG. 13), scattered light (e.g., natural light as illustrated in FIG. 3 or 4), transmitted light, diffracted light, or excited light (e.g., fluorescence image as illustrated in FIG. 12).

At 1704, the light from the visual scene is linearly transformed into first optical outputs by the first optical linear layer that is trained to perform a first optical linear operation.

The first optical linear operation can include at least one of multiplication, convolution, or multiplexing. In some embodiments, the first optical linear layer includes: an optical fan-out device configured to multiplex one optical input into multiple optical inputs (e.g., as illustrated in FIG. 7A), an optical modulator arranged downstream of the optical fan-out device and configured to modulate corresponding weights to the multiple optical inputs to generate multiple weighted optical inputs (e.g., as illustrated in FIG. 7B), and an optical fan-in device arranged downstream of the optical modulator and configured to sum up the multiple weighted optical inputs into one or more optical outputs (e.g., as illustrated in FIG. 7C or 7D), each of the one or more optical outputs corresponds to two or more respective weighted optical inputs.

The optical fan-out device can be the optical fan-out device or element 210 of FIG. 2A or 320 of FIG. 3. In some embodiments, the optical fan-out device includes a microlens array. The optical modulator can the optical modulator 220 of FIG. 2A or 324 of FIG. 3. In some embodiments, the optical modulator includes a spatial light modulator (SLM) or an LCD. The optical fan-in device can be the optical fan-in device 230 of FIG. 2A or 326 of FIG. 3. In some embodiments, the optical fan-in device includes an optical lens, a microlens array, or a waveguide.

At 1706, second optical outputs are nonlinearly generated based on the first optical outputs by the optical nonlinear layer in the nonlinear ONN. The optical nonlinear layer can include an optical nonlinear device configured to perform an optical nonlinear operation. The optical nonlinear operation can include at least one of optical amplifying, saturating, or rectifying and attenuating. The optical nonlinear operation can be unrelated to the first optical linear operation.

In some examples, the optical nonlinear operation corresponds to a ReLU function, a sigmoid function, or an unconventional nonlinear function that is different from a nonlinear function used in digital computing. In some examples, the optical nonlinear device comprises an optical intensifier (e.g., the image intensifier 250 of FIG. 2B or 330 of FIG. 3), a photoconductor configured to response nonlinearly to light intensity, a light source configured to response nonlinearly to a driving current, or a nonlinear optical medium.

At 1708, the second optical outputs are linearly transformed by the second optical linear layer in the nonlinear ONN. The second optical linear layer is trained to perform a second optical linear operation. The second optical linear operation can correspond to the first optical linear operation. The second optical linear layer can have a same structure as the first optical linear layer but with one or more different structure parameters, e.g., as illustrated in FIG. 3. The second optical linear operation can be same as the first optical linear operation, e.g., as illustrated in FIG. 3. For example, the second optical linear operation can include at least one of multiplication, convolution, or multiplexing. The second optical linear layer can include an optical fan-out device (e.g., 210 of FIG. 2A or 342 of FIG. 3), an optical modulator (e.g., 220 of FIG. 2A or 344 of FIG. 3), and an optical fan-in device (e.g., 230 of FIG. 2A or 346 of FIG. 3). In some embodiments, the second optical linear layer has a different configuration from the first optical linear layer. In some embodiments, the second optical linear operation is different from the first optical linear operation.

In some embodiments, an optoelectronic device is optically coupled to the ONN apparatus and configured to perform an optical-to-electrical (OE) conversion of an optical output signal of the ONN apparatus into an electrical data signal. The optoelectronic device can be the optical detector 120 of FIG. 1 or 304 of FIG. 3. In some examples, the optoelectronic device includes one or more photodetectors.

In some embodiments, a digital backend, e.g., a computing device, is coupled to the optoelectronic device and configured to process digital data associated with the electrical data signal to generate a digital output corresponding to the visual scene. The digital backend can be the digital backend 130 of FIG. 1 or 306 of FIG. 3. The digital output can identify one or more objects in the visual scene, e.g., as illustrated in FIGS. 5, 11, 12, or 13. An identification accuracy of the digital output can be higher than an identification accuracy of a digital output using a second apparatus that includes an optical linear layer followed by a digital linear layer without nonlinearity, e.g., as illustrated in FIGS. 10A, 10B, 11, 12, 13, or 16C.

In some embodiments, a ratio between an intensity of the light and an intensity of the third optical outputs is more than two orders of magnitude. In some embodiments, an information percentage of an object at interest in an optical output signal from the nonlinear ONN apparatus is at least one order of magnitude (or over two orders of magnitude) higher than an information percentage of the object at interest in the light from the visual scene received by the nonlinear ONN apparatus, e.g., as illustrated in FIGS. 5, 15A, or 15B.

In some embodiments, the first optical linear layer and the second optical linear layer are trained or calibrated together in a digital neural network model corresponding to the ONN apparatus. The optical nonlinear layer can be also calibrated to determine at least one property of the optical nonlinear device.

In some embodiments, calibrating the optical nonlinear device includes: measuring an input intensity into the optical nonlinear device, measuring an output intensity from the optical nonlinear device, and determining a mathematical function or model between the input intensity and the output intensity, e.g., as illustrated in FIG. 8A or FIG. 4(d).

In some embodiments, the nonlinear ONN apparatus is trained by building a digital neural network model corresponding to the ONN apparatus based on the at least one property of the optical nonlinear device, and training the digital neural network model to determine one or more parameters for the first optical linear layer and the second optical linear layer.

In some embodiments, the nonlinear ONN apparatus is trained by controlling the first optical linear layer and the second optical linear layer in the ONN apparatus with the determined parameters, measuring the first optical outputs for the first optical linear layer, measuring the third optical outputs for the second optical linear layer, first comparing the measured first optical outputs to first ground truth information for the first optical linear layer, second comparing the measured third optical outputs to second ground truth information for the second optical linear layer, and calibrating the ONN apparatus or re-training the digital neural network model based on a first result of the first comparing and a second result of the second comparing.

In some examples, at least one of the first result or the second result includes: a plurality of error calibration curves (e.g., as illustrated in FIG. 7C or FIG. 9C or 9D) or root mean square error (RMSE) values (e.g., as illustrated in FIG. 7D).

In some embodiments, the digital neural network model is trained by adjusting the one or more parameters for the first optical linear layer and the second optical linear layer to achieve a performance result substantially close to a performance result obtained by using a ground truth neural network.

In some embodiments, data augmentation on training data of the digital neural network model is performed with random image misalignments and convolutions. In some embodiments, layer-by-layer fine tuning of the digital neural network model with experimentally collected data is performed.

In some embodiments, e.g., as illustrated in FIG. 1, the ONN apparatus includes a plurality of optical nonlinear layers, each of the plurality of optical nonlinear layers being coupled between adjacent optical linear layers. The ONN apparatus can include multiple pairs of optical nonlinear layer and optical linear layer that are sequentially arranged downstream the first optical linear layer. The performance of the ONN apparatus can be scaled up by using one or more nonlinear layers and/or one or more linear layers, e.g., as illustrated in FIGS. 16B-16C.

In some embodiments, the light includes different colors of light corresponding to a plurality of wavelengths, and at least one of the first optical linear layer or the second optical linear layer is configured to perform a respective optical linear operation for each of the plurality of wavelengths.

In some embodiments, the process 1700 further includes: using feature vectors produced by the ONN apparatus as input to a digital backend for a further operation that comprises at least one of neural-network decoding or image reconstruction, unsupervised learning, or nonlinear regression, e.g., as illustrated in FIG. 14.

The disclosed and other examples can be implemented as one or more computer program products, for example, one or more modules of computer program instructions encoded on a computer readable medium for execution by, or to control the operation of, data processing apparatus. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A system may encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

A number of implementations have been described. Nevertheless, it will be understood that various modifications may be made without departing from the spirit and scope of the techniques and devices described herein. For example, phase perturbation or variation methods discussed above may be implemented in diffractive structures to remove high frequency artifacts or medium frequency artifacts in interference patterns. Features shown in each of the implementations may be used independently or in combination with one another. Additional features and variations may be included in the implementations as well. Accordingly, other implementations are within the scope of the following claims.

What is claimed is:

1. (canceled)

2.-43. (canceled)

44. A method, comprising:
receiving light from a visual scene by a first optical linear layer in a nonlinear optical neural network (ONN) apparatus;
linearly transforming the light into first optical outputs by the first optical linear layer that is trained to perform a first optical linear operation;
nonlinearly generating second optical outputs based on the first optical outputs by an optical nonlinear layer in the ONN apparatus; and
linearly transforming the second optical outputs into third optical outputs by a second optical linear layer in the ONN apparatus that is trained to perform a second optical linear operation,
wherein the first optical linear layer, the optical nonlinear layer, and the second optical linear layer are sequentially arranged in series in the ONN apparatus.

45. The method of claim 44, further comprising:
performing, by an optoelectronic device coupled to the ONN apparatus, an optical-to-electrical (OE) conversion of an optical output signal of the ONN apparatus into an electrical data signal.

46. The method of claim 45, further comprising:
processing, by a computing device coupled to the optoelectronic device, digital data associated with the electrical data signal to generate a digital output corresponding to the visual scene,
wherein the digital output identifies one or more objects in the visual scene, and
wherein an identification accuracy of the digital output is higher than an identification accuracy of a digital output using a second apparatus that includes an optical linear layer followed by a digital linear layer without nonlinearity.

47. The method of claim 44, wherein an information percentage of an object at interest in an optical output signal from the nonlinear ONN apparatus is at least one order of magnitude higher than an information percentage of the object at interest in the light from the visual scene received by the nonlinear ONN apparatus.

48. The method of claim 44, wherein the light comprises incoherent light or coherent light.

49. The method of claim 44, wherein the light comprises different colors of light corresponding to a plurality of wavelengths, and
wherein at least one of the first optical linear layer or the second optical linear layer is configured to perform a respective optical linear operation for each of the plurality of wavelengths.

50. The method of claim 44, wherein the light from the visual scene comprises at least one of reflected light, scattered light, transmitted light, diffracted light, or excited light.

51. The method of claim 44, wherein the visual scene comprises at least one of: an image, a video, a real-life scene, a virtual scene, a two-dimensional (2D) object, a three-dimensional (3D) object, an image of a plurality of drawings corresponding to one or more objects, one or more fluorescence images of biological objects, or one or more real-scene objects.

52. The method of claim 44, wherein at least one of the first optical linear operation or the second optical linear operation comprises at least one of multiplication, convolution, or multiplexing.

53. The method of claim 44, wherein at least one of the first optical linear layer and the second optical linear layer comprises:
an optical fan-out device configured to multiplex one optical input into multiple optical inputs;
an optical modulator arranged downstream of the optical fan-out device and configured to modulate corresponding weights to the multiple optical inputs to generate multiple weighted optical inputs; and
an optical fan-in device arranged downstream of the optical modulator and configured to sum up the multiple weighted optical inputs into one or more optical outputs, wherein each of the one or more optical outputs corresponds to two or more respective weighted optical inputs.

54. The method of claim 53, wherein the optical fan-out device comprises a microlens array, wherein the optical modulator comprises a spatial light modulator (SLM), and wherein the optical fan-in device comprises an optical lens, a microlens array, or a waveguide.

55. The method of claim 44, wherein the first optical linear layer and the second optical linear layer are trained together in a digital neural network model corresponding to the ONN apparatus.

56. The method of claim 44, wherein the optical nonlinear layer comprises an optical nonlinear device configured to perform an optical nonlinear operation, and
wherein the optical nonlinear operation comprises at least one of optical amplifying, saturating, or rectifying and attenuating.

57. The method of claim 56, wherein the optical nonlinear operation corresponds to a ReLU function, a sigmoid function, or an unconventional nonlinear function that is different from a nonlinear function used in digital computing,
wherein the optical nonlinear device comprises an optical intensifier, a photoconductor configured to response nonlinearly to light intensity, a light source configured to response nonlinearly to a driving current, or a nonlinear optical medium, and
wherein the optical nonlinear operation is unrelated to the first optical linear operation and the second optical linear operation.

58. The method of claim wherein the optical nonlinear layer comprises an optical nonlinear device,
wherein the method further comprises: calibrating the optical nonlinear device to determine at least one property of the optical nonlinear device, and
wherein calibrating the optical nonlinear device comprises:
measuring an input intensity into the optical nonlinear device;
measuring an output intensity from the optical nonlinear device; and
determining a mathematical function or model between the input intensity and the output intensity.

59. The method of claim 58, further comprising:
building a digital neural network model corresponding to the ONN apparatus based on the at least one property of the optical nonlinear device;
training the digital neural network model to determine one or more parameters for the first optical linear layer and the second optical linear layer;
controlling the first optical linear layer and the second optical linear layer in the ONN apparatus with the determined parameters;
measuring the first optical outputs for the first optical linear layer;
measuring the third optical outputs for the second optical linear layer,
first comparing the measured first optical outputs to first ground truth information for the first optical linear layer;
second comparing the measured third optical outputs to second ground truth information for the second optical linear layer; and
calibrating the ONN apparatus or re-training the digital neural network model based on a first result of the first comparing and a second result of the second comparing,
wherein training the digital neural network model by adjusting the one or more parameters for the first optical linear layer and the second optical linear layer to achieve a performance result substantially close to a performance result obtained by using a ground truth neural network, and
wherein the method further comprises:
performing data augmentation on training data of the digital neural network model with random image misalignments and convolutions; and
performing layer-by-layer fine tuning of the digital neural network model with experimentally collected data.

60. The method of claim 44, further comprising:
using feature vectors produced by the ONN apparatus as input to a digital backend for a further operation that comprises at least one of neural-network decoding or image reconstruction, unsupervised learning, or nonlinear regression.

61. The method of claim 44, wherein the ONN apparatus comprises a plurality of optical nonlinear layers, each of the plurality of optical nonlinear layers being coupled between adjacent optical linear layers, and
wherein the ONN apparatus comprises multiple pairs of optical nonlinear layer and optical linear layer that are sequentially arranged downstream the first optical linear layer.

62. An optical neural network (ONN) apparatus, comprising:
a first optical linear layer configured to receive light from a visual scene and linearly transform the light into first optical outputs according to a first optical linear operation;
an optical nonlinear layer coupled to the first optical linear layer and configured to nonlinearly generate second optical outputs based on the first optical outputs; and
a second optical linear layer coupled to the optical nonlinear layer and configured to linearly transform the second optical outputs into third optical outputs according to a second optical linear operation,
wherein the first optical linear layer, the optical nonlinear layer, and the second optical linear layer are sequentially coupled in series in the ONN apparatus.

63. A system, comprising:
an optical neural network (ONN) apparatus comprising:
a first optical linear layer configured to receive light from a visual scene and linearly transform the light into first optical outputs according to a first optical linear operation;
an optical nonlinear layer coupled to the first optical linear layer and configured to nonlinearly generate second optical outputs based on the first optical outputs; and
a second optical linear layer coupled to the optical nonlinear layer and configured to linearly transform the second optical outputs into third optical outputs according to a second optical linear operation,
wherein the first optical linear layer, the optical nonlinear layer, and the second optical linear layer are sequentially coupled in series in the ONN apparatus;
an optoelectronic device coupled to the ONN apparatus and configured to perform an optical-to-electric (OE) conversion of an optical signal output of the ONN apparatus into an electric data signal, the optical signal output of the ONN apparatus being associated with the third optical outputs; and
a computing device coupled to the optoelectronic device and configured to process digital data associated with the electric data signal to generate a digital output corresponding to the visual scene.
